(19) United States
(12) Patent Application Publication
(10) Pub. No.: US 2023/0358560 A1
(43) Pub. Date: Nov. 9, 2023

(54) MAP DATA MANAGEMENT APPARATUS AND MAP DATA MANAGEMENT METHOD

(71) Applicant: Mitsubishi Electric Corporation, Tokyo (JP)

(72) Inventors: Seigo KANAZAWA, Tokyo (JP); Mitsuo SHIMOTANI, Tokyo (JP); Yasushi KODAKA, Tokyo (JP); Keisuke INOUE, Tokyo (JP)

(73) Assignee: Mitsubishi Electric Corporation, Tokyo (JP)

(21) Appl. No.: 18/026,382

(22) PCT Filed: Oct. 23, 2020
(86) PCT No.: PCT/JP2020/039884

§ 371 Date: Mar. 15, 2023

(51) Int. Cl. G01C 21/00

(52) U.S. Cl. CPC G01C 21/3819; G01C 21/387; G01C 21/3896

(57) ABSTRACT

A map update controller of a map data management apparatus predicts meshes whose pieces of map data will be requested from a map application, and identifies meshes whose pieces of map data stored in the map database are not latest as update-necessary meshes, from among the predicted meshes whose pieces of map data will be requested. The map update controller performs a first map update process of immediately updating pieces of map data of the update-necessary meshes when the pieces of map data of the update-necessary meshes can be updated before the map application requests the pieces of map data of the update-necessary meshes, and performs a second map update process of updating the pieces of map data of the update-necessary meshes at the timing that an operation of the map application satisfies a predefined condition when the pieces of map data cannot be updated.

### TECHNICAL FIELD

The present disclosure relates to a map data management apparatus that manages an update of pieces of map data.

### BACKGROUND ART

In-vehicle apparatuses each executing a map application that operates using pieces of map data provided from a map database, for example, car navigation apparatuses, advanced driver-assistance systems (ADAS), and automatic driving apparatuses have been put to practical use. Such in-vehicle apparatuses preferably have a function of downloading and obtaining the latest pieces of map data from a map distribution server and updating pieces of map data stored in a map database included in the in-vehicle apparatus, to provide the latest pieces of map data to a map application.

Typically, map data is stored in a map database for each of zones into which a map is partitioned in a mesh-shaped design (this zone will be referred to as a mesh). For example, Patent Document 1 below discloses a map data management apparatus that efficiently updates pieces of map data by preferentially updating pieces of map data in meshes with higher priorities, for example, meshes around a particular point of interest (POI) such as a home of a user, and meshes including a route from a current position to a destination of a vehicle.

### PRIOR-ART DOCUMENT

### Patent Document

Patent Document 1: Japanese Patent Application Laid-Open No. 2012-123418

### SUMMARY

### Problems to be Solved by the Invention

It is preferred that map data management apparatuses always provide the latest pieces of map data to a map application. However, old non-updated pieces of map data are sometimes provided to the map application because pieces of map data are not updated in time in response to a request for pieces of map data from the map application. This occurs, for example, when it takes much time to identify a mesh requiring an update of a piece of map data, when meshes each requiring an update of a piece of map data are densely packed, or when a traveling speed of a vehicle is faster. When a piece of old map data mixed with a piece of latest map data is provided to the map application, there is a possibility that the map application cannot operate normally. Recent years have seen the use of pieces of high-definition map data including road shape information for each lane. Thus, it takes much time to download the pieces of map data, and the pieces of map data are frequently not updated in time.

The present disclosure has been conceived to solve the problems, and has an object of providing a map data management apparatus that prevents mixing a piece of old map data with a piece of latest map data and providing the mixed pieces of map data to a map application.

### Means to Solve the Problems

A map data management apparatus according to a first aspect of the present disclosure includes: a map database to store a piece of map data of each of meshes into which a map is partitioned in a mesh-shaped design; a map access unit to provide, in response to a request from a map application, the map application with the pieces of map data stored in the map database; an update map data obtaining unit to obtain, from a map distribution server, a piece of update map data that is a piece of latest map data of each of the meshes; and a map update controller to update the pieces of map data stored in the map database using the pieces of update map data, wherein the map update controller predicts meshes whose pieces of map data will be requested from the map application, identifies meshes whose pieces of map data stored in the map database are not latest as update-necessary meshes, from among the predicted meshes whose pieces of map data will be requested, performs a first map update process of immediately updating pieces of map data of the update-necessary meshes when the map update controller can update the pieces of map data of the update-necessary meshes before the map application requests the pieces of map data of the update-necessary meshes, and performs a second map update process of updating the pieces of map data of the update-necessary meshes at the timing that an operation of the map application satisfies a predefined condition when the map update controller cannot update the pieces of map data of the update-necessary meshes before the map application requests the pieces of map data of the update-necessary meshes.

A map data management apparatus according to the second aspect of the present disclosure includes: a map database to store a piece of map data of each of meshes into which a map is partitioned in a mesh-shaped design; a map access unit to provide, in response to a request from a map application, the map application with the pieces of map data stored in the map database; an update map data obtaining unit to obtain, from a map distribution server, a piece of update map data that is a piece of latest map data of each of the meshes; and a map update controller to update the pieces of map data stored in the map database using the pieces of update map data, wherein the pieces of map data stored in the map database include pieces of high-definition map data including road shape information for each lane, and the map update controller predicts, as meshes whose pieces of map data will be requested from the map application, meshes with the pieces of high-definition map data that are connected from a mesh to which a current position belongs or meshes with the pieces of high-definition map data of roads that are connected from a road in the mesh to which the current position belongs, identifies meshes whose pieces of map data stored in the map database are not latest as update-necessary meshes, from among the predicted meshes whose pieces of map data will be requested, and updates pieces of map data of the update-necessary meshes.

### Effects of the Invention

The map data management apparatus according to the first aspect of the present disclosure updates the pieces of map data of the update-necessary meshes not soon but later when the pieces of map data of the update-necessary meshes cannot be updated before the map application requests the pieces of map data of the update-necessary meshes. This prevents mixing a piece of old map data with a piece of latest map data and providing the mixed pieces of map data to the map application.

The map data management apparatus according to the second aspect of the present disclosure performs a process of predicting meshes whose pieces of map data will be requested from the map application, based on the connection of meshes with pieces of high-definition map data. Thus, the probability of failing to update pieces of map data in time is low. This consequently prevents mixing a piece of old map data with a piece of latest map data and providing the mixed pieces of map data to the map application.

The objects, features, aspects and advantages of the present disclosure will become more apparent from the following detailed description and the accompanying drawings.

### BRIEF DESCRIPTION OF DRAWINGS

FIG. 1 is a block diagram illustrating a configuration of a map data management apparatus according to Embodiment 1.

FIG. 2 is a flowchart illustrating operations of a map application.

FIG. 3 illustrates example meshes into which a map is partitioned.

FIG. 4 illustrates an example map indicated by pieces of map data.

FIG. 5 illustrates pieces of map data to be provided to the map application.

FIG. 6 illustrates pieces of map data to be provided to the map application.

FIG. 7 illustrates pieces of map data to be provided to the map application.

FIG. 8 illustrates, as an example, predicted meshes whose pieces of map data will be requested and update-necessary meshes.

FIG. 9 illustrates example pieces of update necessity data.

FIG. 10 illustrates an example state where pieces of map data can be updated before the map application requests the pieces of map data.

FIG. 11 illustrates an example state where pieces of map data cannot be updated before the map application requests the pieces of map data.

FIG. 12 is a flowchart illustrating operations of the map data management apparatus according to Embodiment 1.

FIG. 13 is a block diagram illustrating a modification of the map data management apparatus according to Embodiment 1.

FIG. 14 is a flowchart illustrating modifications of operations of the map data management apparatus according to Embodiment 1.

FIG. 15 is a flowchart illustrating the modifications of operations of the map data management apparatus according to Embodiment 1.

FIG. 16 is a block diagram illustrating a configuration of a map data management apparatus according to Embodiment 2.

FIG. 17 illustrates example meshes with pieces of high-definition map data.

FIG. 18 illustrates example pieces of mesh connection management data.

FIG. 19 illustrates, as an example, predicted meshes whose pieces of map data will be requested and update-necessary meshes.

FIG. 20 is a flowchart illustrating operations of the map data management apparatus according to Embodiment 2.

FIG. 21 illustrates, as an example, predicted meshes whose pieces of map data will be requested and update-necessary meshes.

FIG. 22 illustrates, as an example, predicted meshes whose pieces of map data will be requested and update-necessary meshes.

FIG. 23 illustrates, as an example, predicted meshes whose pieces of map data will be requested and update-necessary meshes.

FIG. 24 illustrates, as an example, predicted meshes whose pieces of map data will be requested and update-necessary meshes.

FIG. 25 is a block diagram illustrating a configuration of a map data management apparatus according to Embodiment 3.

FIG. 26 is a block diagram illustrating a configuration of a map data management apparatus according to Embodiment 4.

FIG. 27 is a flowchart illustrating operations of the map application according to Embodiment 4.

FIG. 28 is a flowchart illustrating operations of the map data management apparatus according to Embodiment 4.

FIG. 29 illustrates an example hardware configuration of the map data management apparatus.

FIG. 30 illustrates an example hardware configuration of the map data management apparatus.

### DESCRIPTION OF EMBODIMENTS

### Embodiment 1

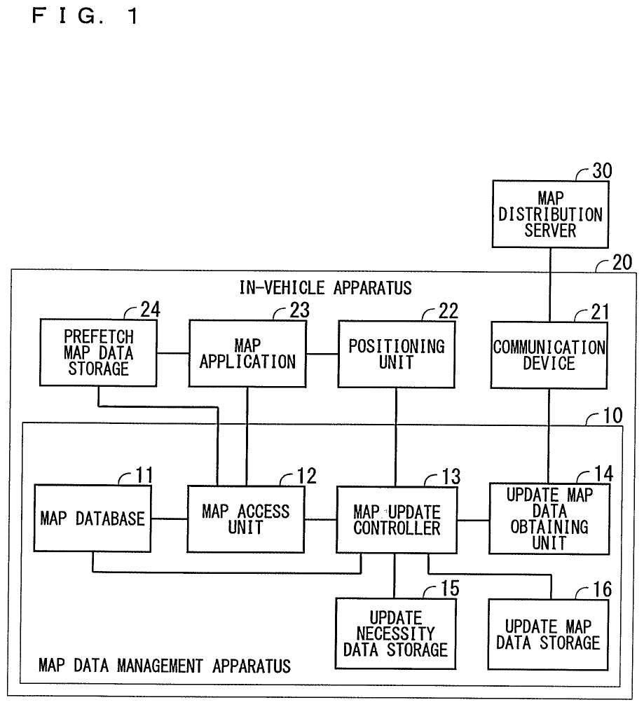

FIG. 1 is a block diagram illustrating a configuration of a map data management apparatus 10 according to Embodiment 1. As illustrated in FIG. 1, the map data management apparatus 10 is incorporated into an in-vehicle apparatus 20 including a communication device 21, a positioning unit 22, a map application 23, and a prefetch map data storage 24. Hereinafter, a vehicle equipped with the in-vehicle apparatus 20 will be referred to as a “subject vehicle”.

The map data management apparatus 10 need not always be incorporated into the in-vehicle apparatus 20 but may be a mobile device external to the in-vehicle apparatus 20, for example, a mobile phone or a smartphone. Furthermore, a part of functions of the map data management apparatus 10 may be constructed in an external server that can communicate with the map data management apparatus 10.

The communication device 21 is a communication means for the in-vehicle apparatus 20 to perform external communication. The map data management apparatus 10 can access a map distribution server 30 that distributes pieces of latest map data, via the communication device 21. The communication device 21 may be a communication means dedicated to the in-vehicle apparatus 20, or a general-purpose communication means such as a mobile phone or a smartphone.

The positioning unit 22 measures a current position of the subject vehicle, using, for example, a positioning signal received from a global navigation satellite system (GNSS), output of a sensor (e.g., a speed sensor or an azimuth sensor) of the subject vehicle, or pieces of map data obtained from the map data management apparatus 10.

The map application 23 is a functional block built by the in-vehicle apparatus 20 through executing a program, and implements, for example, a navigation function, an ADAS function, and an automated driving function. The map application 23 requests the map data management apparatus 10 to provide pieces of map data required to perform the operations, and implements each of the functions using the pieces of map data provided from the map data management apparatus 10.

The map application 23 can obtain information required to implement each of the functions from, for example, a perimeter sensor or a vehicle state sensor of the subject vehicle, although an illustration thereof is omitted. When the map application 23 implements, for example, the ADAS function or the automated driving function, it can control a driving control system including a steering wheel, an accelerator, and a brake of the subject vehicle. When the map application 23 implements the navigation function, for example, an operational input device through which the user enters a destination, a display that presents a planned travel route to the user, and a voice output device that provides route guidance to the user by voice are connected to the in-vehicle apparatus 20.

The prefetch map data storage 24 is a temporary memory storing the pieces of map data provided from the map data management apparatus 10 to the map application 23. The prefetch map data storage 24 may be a cache memory that the map application 23 can access at a high speed.

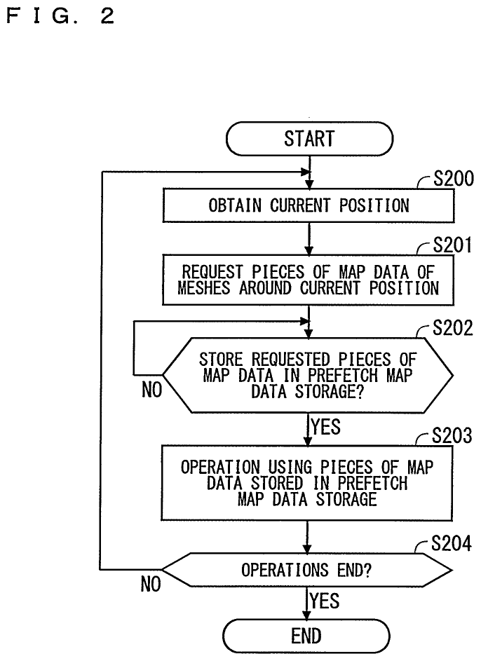

Here, operations of the map application 23 will be described with reference to the flowchart in FIG. 2. Once starting the operations, the map application 23 obtains a current position of the subject vehicle from the positioning unit 22 (Step S200). Then, the map application 23 requests the map data management apparatus 10 to provide pieces of map data of meshes around the current position of the subject vehicle (Step S201). The map application 23 waits for the requested pieces of map data to be stored in the prefetch map data storage 24 (Step S202).

Once the requested pieces of map data are stored in the prefetch map data storage 24 (YES in Step S202), the map application 23 performs an operation using the pieces of map data stored in the prefetch map data storage 24, that is, the pieces of map data provided from the map data management apparatus 10 (Step S203). This implements, for example, the navigation function, the ADAS function, or the automated driving function.

The map application 23 repeats the aforementioned operations until the operations end (until YES in Step S204), for example, when the power of the in-vehicle apparatus 20 is turned off.

Referring back to FIG. 1, the map data management apparatus 10 includes a map database 11, a map access unit 12, a map update controller 13, an update map data obtaining unit 14, an update necessity data storage 15, and an update map data storage 16.

The map database 11 is a storage medium storing a piece of map data of each of meshes into which a map is partitioned in a mesh-shaped design. In Embodiment 1, the piece of map data stored in the map database 11 is a piece of high-definition map data (may be hereinafter referred to as “HD map data”) including road shape information for each lane.

The pieces of map data in the map database 11 are managed per mesh. Specifically, a piece of map data of one mesh is managed as one file. Thus, the pieces of map data stored in the map database 11 can be updated per mesh (i.e., per file). There is no constraint on a method for managing the pieces of map data in the map database 11. For example, pieces of map data of a plurality of meshes may be regarded as one file, or pieces of map data of one mesh may be divided into a plurality of files. Furthermore, there is no constraint on the size of one mesh. For example, a rectangle of 1 km×1 km may be regarded as one mesh.

In response to the request from the map application 23, the map access unit 12 provides the map application 23 with the pieces of map data stored in the map database 11. In Embodiment 1, the pieces of map data provided to the map application 23 are stored in the prefetch map data storage 24 that is a temporary memory. In other words, the map access unit 12 provides the pieces of map data to the map application 23 by storing the pieces of map data in the prefetch map data storage 24.

In Embodiment 1, the map application 23 requests the map access unit 12 to provide pieces of map data of 3×3 meshes having its center at a mesh to which the current position of the subject vehicle belongs. Here, the prefetch map data storage 24 should have a storage capacity large enough to store at least the pieces of map data of 3×3 meshes. In Embodiment 1, the prefetch map data storage 24 can store pieces of map data of meshes larger than 3×3 meshes (e.g., 9×9 or 18×18). When the capacity is full, a piece of data with an older writing time is first overwritten as being performed in a ring buffer.

An area of meshes of pieces of map data that the map application 23 requests at one time is not limited to an area of 3×3, and is not necessarily rectangular. For example, the map application 23 may request pieces of map data of meshes in an area that is longer along a road along which the subject vehicle is traveling or along a planned travel route of the subject vehicle, or pieces of map data of meshes in an area wider ahead of the subject vehicle (in a traveling direction) than behind the subject vehicle.

The map update controller 13 performs a process of updating the pieces of map data stored in the map database 11. The update map data obtaining unit 14 accesses the map distribution server 30 via the communication device 21, and downloads and obtains the pieces of latest map data to be used for updating the pieces of map data, from the map distribution server 30. The pieces of latest map data downloaded by the update map data obtaining unit 14 from the map distribution server 30 will be referred to as “pieces of update map data”.

The update necessity data storage 15 is a storage medium storing a piece of update necessity data that is a piece of data for managing, per mesh, whether the piece of map data stored in the map database 11 needs to be updated (i.e., whether the piece of map data is the latest). In Embodiment 1, the map update controller 13 compares, in advance (e.g., when the map data management apparatus 10 is started), a version of a piece of map data of each mesh stored in the map database 11 with a version of a piece of map data of each mesh stored in the map distribution server 30 to check whether the piece of map data of each mesh stored in the map database 11 needs to be updated, and stores, in the update necessity data storage 15, the result as the piece of update necessity data. Storing, in advance, the piece of update necessity data in the update necessity data storage can reduce the number of times the map update controller 13 accesses the map distribution server 30 to check whether a piece of map data needs to be updated, and accelerate the processes.

Although the number of times the map update controller 13 accesses the map distribution server 30 is increased, the map update controller 13 may access the map distribution server 30 to check whether a piece of map data needs to be updated, each time such a need arises.

The update map data storage 16 is a storage medium that can temporarily store pieces of update map data downloaded by the map update controller 13 from the map distribution server 30. The update map data storage 16 stores pieces of update map data when the pieces of map data stored in the map database 11 are not updated in time in response to a request for pieces of map data from the map application 23, which will be described in detail later.

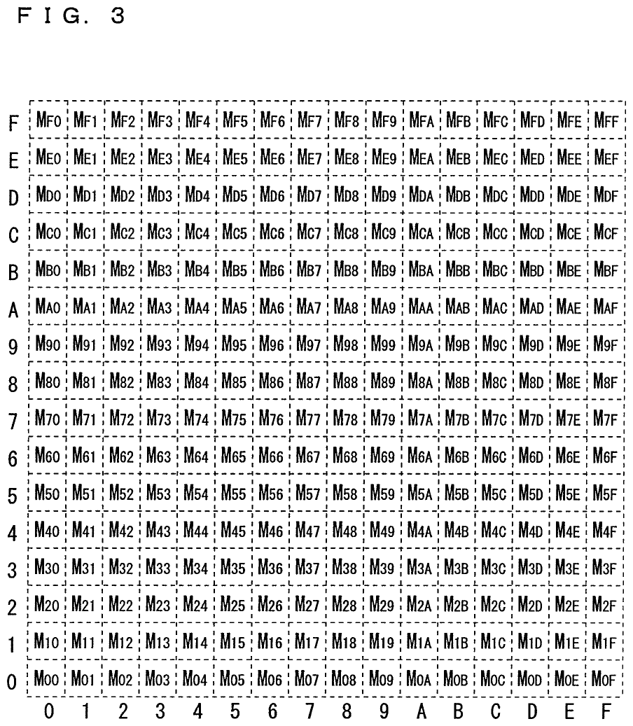

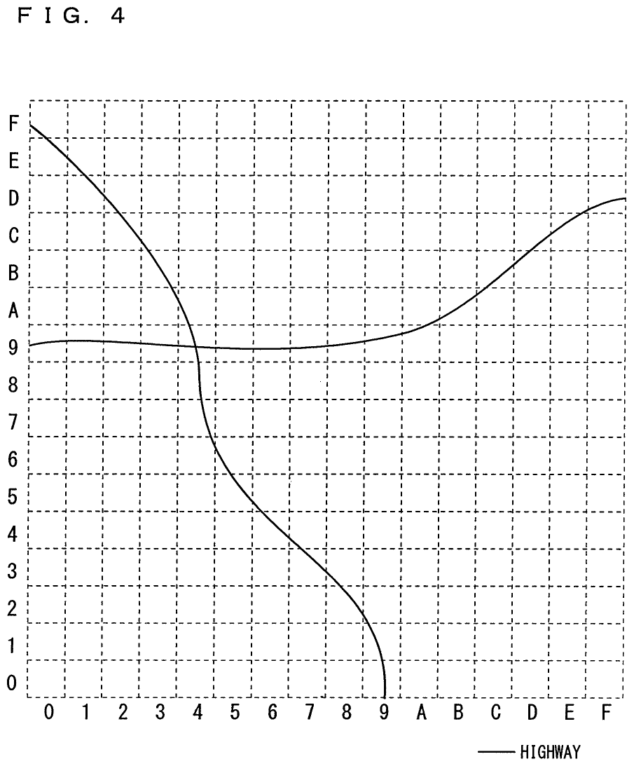

Here, specific example operations of the map access unit 12 will be described. For simplifying the following description, it is assumed that the map database 11 stores pieces of map data which indicate a map in FIG. 4 and are partitioned into 16×16 meshes in FIG. 3. A row number and a column number each indicated by one of 0 to F (denoted by a hexadecimal number) are attached to each of the 16×16 meshes. Thus, “ij” is given to a mesh in an i row and in a j column as an identifier (ID). Hereinafter, the mesh in the i row and in the j column (mesh whose ID is “ij”) is denoted by a “mesh Mᵢⱼ”.

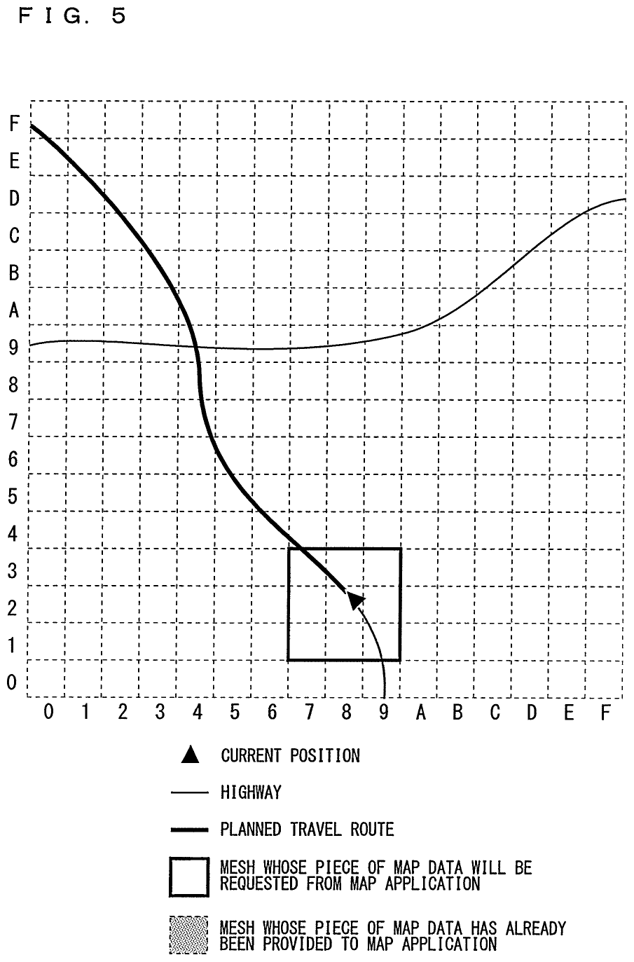

Once starting the operations, the map application 23 requests the map data management apparatus 10 to provide, when the position of the subject vehicle is, for example, in a mesh M₂₈ as illustrated in FIG. 5, pieces of map data of 3×3 meshes having its center at the mesh M₂₈, that is, pieces of map data of meshes M₁₇, M₁₈, M₁₉, M₂₇, M₂₈, M₂₉, M₃₇, M₃₈, and M₃₉. In response to the request from the map application 23, the map access unit 12 of the map data management apparatus 10 provides the map application 23 with the pieces of map data of these meshes by storing the pieces of map data in the prefetch map data storage 24.

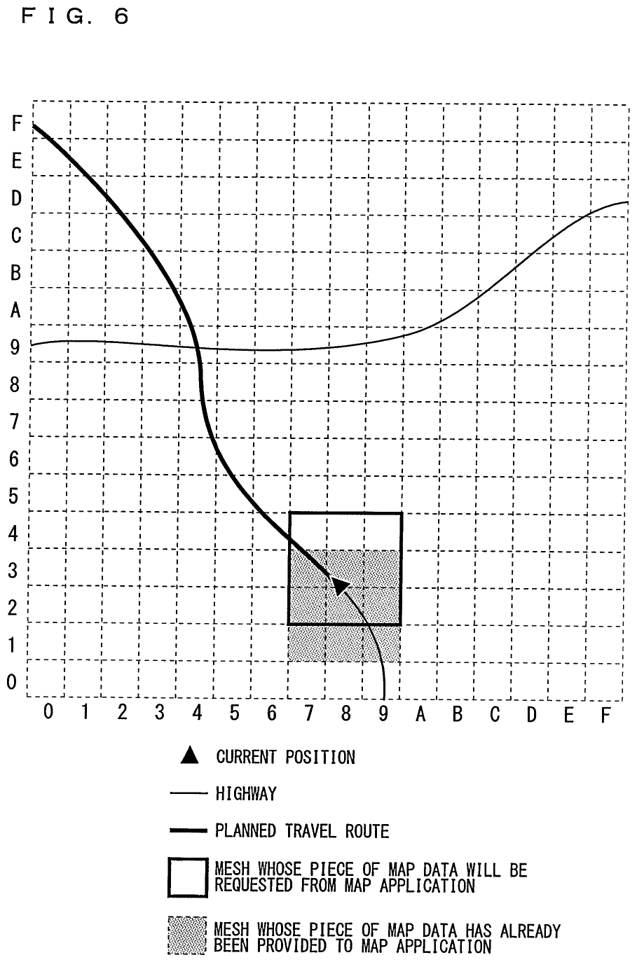

Then, when the position of the subject vehicle moves to a mesh M₃₈ as illustrated in FIG. 6, the map application 23 requests the map access unit 12 to provide pieces of map data of 3×3 meshes having its center at the mesh M₃₈, that is, pieces of map data of meshes M₂₇, M₂₈, M₂₉, M₃₇, M₃₈, M₃₉, M₄₇, M₄₈, and M₄₉. Here, the map access unit 12 needs to provide the pieces of map data of these meshes to the map application 23. However, the pieces of map data of the meshes M₂₇, M₂₈, M₂₉, M₃₇, M₃₈, and M₃₉ have already been provided to the map application 23 (stored in the prefetch map data storage 24). Thus, the map access unit 12 should store only the pieces of map data of the meshes M₄₇, M₄₈, and M₄₉ in the prefetch map data storage 24.

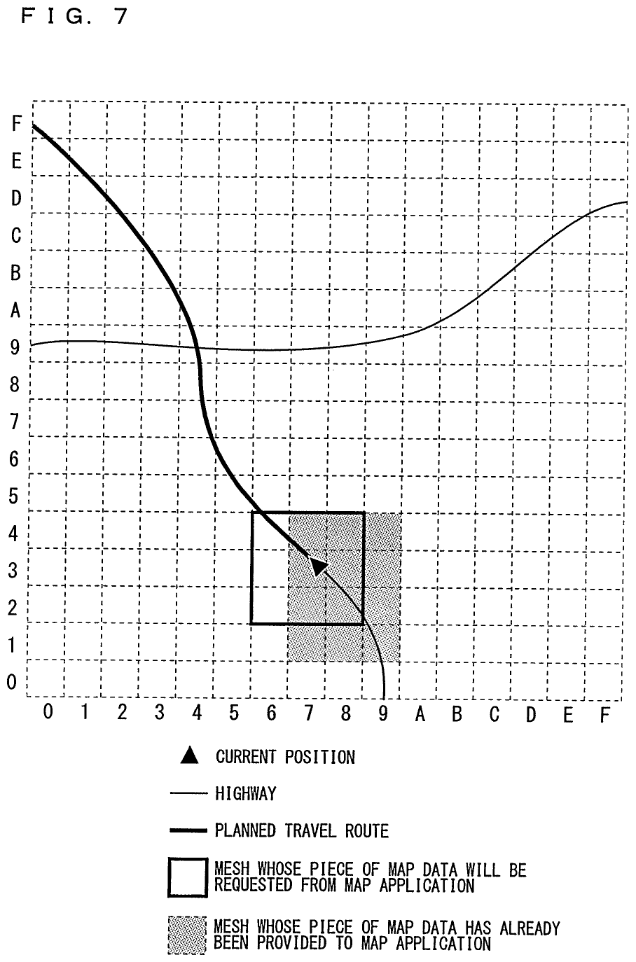

Then, when the position of the subject vehicle further moves to a mesh M₃₇ as illustrated in FIG. 7, the map application 23 requests the map access unit 12 to provide pieces of map data of 3×3 meshes having its center at the mesh M₃₇, that is, pieces of map data of meshes M₂₆, M₂₇, M₂₈, M₃₆, M₃₇, M₃₈, M₄₆, M₄₇, and M₄₈. Here, the pieces of map data of the meshes M₂₇, M₂₈, M₃₇, M₃₈, M₄₇, and M₄₈ have already been stored in the prefetch map data storage 24. Thus, the map access unit 12 should store only the pieces of map data of the meshes M₂₆, M₃₆, and M₄₆ in the prefetch map data storage 24.

As such, preventing the map access unit 12 from redundantly writing, in the prefetch map data storage 24, the pieces of map data already stored in the prefetch map data storage 24 can accelerate the process of providing the pieces of map data to the map application 23.

Next, specific example operations of the map update controller 13 will be described. The map update controller 13 predicts meshes whose pieces of map data will be requested from the map application 23, prior to updating the pieces of map data. In Embodiment 1, the map update controller 13 predicts meshes in a predefined area which include meshes to which a planned travel route of the subject vehicle belongs, as the meshes whose pieces of map data will be requested from the map application 23.

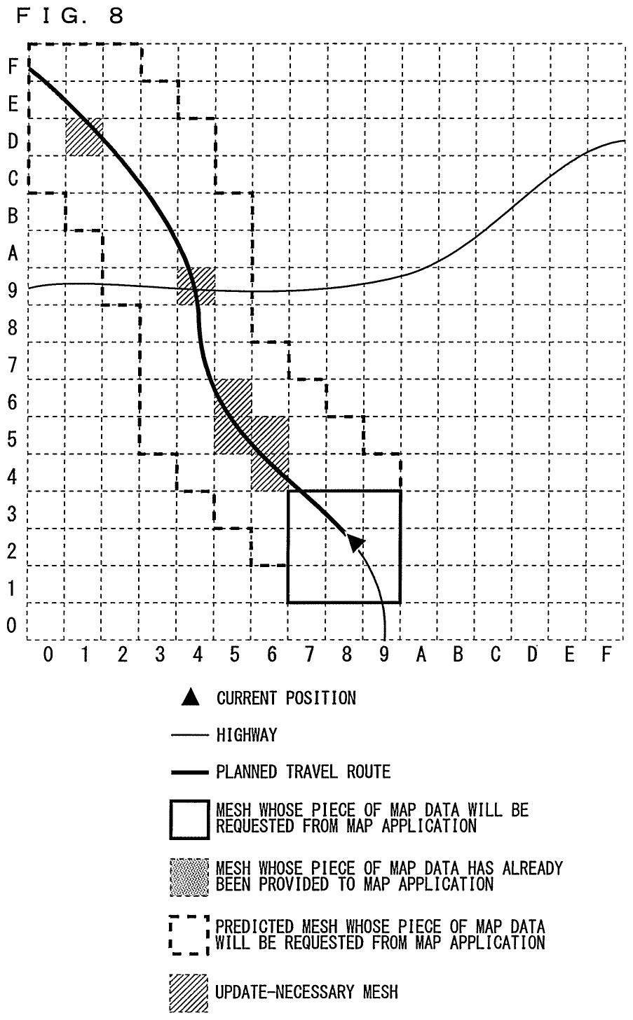

Since the map application 23 requests the pieces of map data of 3×3 meshes having its center at a mesh to which the current position of the subject vehicle belongs in Embodiment 1, the map update controller 13 predicts, as the meshes whose pieces of map data will be requested from the map application 23, meshes ranging from meshes including the planned travel route of the subject vehicle to 3×3 meshes having its center at each of the meshes including the planned travel route. For example, in a state illustrated in FIG. 5, the map update controller 13 predicts, as the meshes whose pieces of map data will be requested from the map application 23, meshes in an area enclosed by thick broken lines in FIG. 8. Hereinafter, the predicted meshes whose pieces of map data will be requested from the map application 23 will be referred to as “predicted requested meshes”.

Once predicting the meshes whose pieces of map data will be requested from the map application 23, the map update controller 13 identifies meshes whose pieces of map data stored in the map database 11 are not the latest as update-necessary meshes, from among the predicted meshes whose pieces of map data will be requested (predicted requested meshes). FIG. 8 illustrates an example where the map update controller 13 determines that pieces of map data of meshes M₄₆, M₅₅, M₅₆, M₆₅, M₉₄, and M_{D1} from among the predicted requested meshes (the meshes in the area enclosed by the thick broken lines) are not the latest and these meshes M₄₆, M₅₅, M₅₆, M₆₅, M₉₄, and M_{D1} are update-necessary meshes.

The map update controller 13 can determine at a high speed whether the piece of map data of each mesh stored in the map database 11 is the latest, with reference to the pieces of update necessity data stored in the update necessity data storage 15.

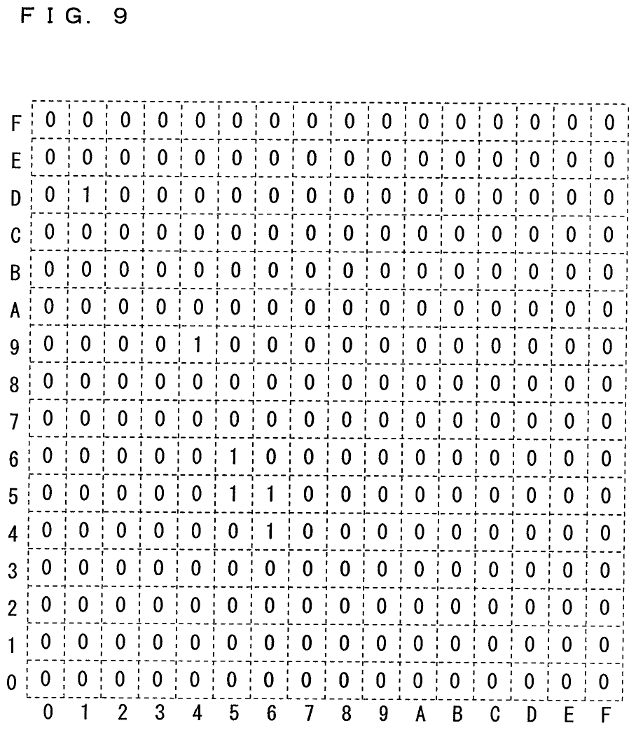

FIG. 9 illustrates an example of the piece of update necessity data of each mesh which is stored in the update necessity data storage 15. In Embodiment 1, the piece of update necessity data of each mesh is a flag stored in an address corresponding to an ID of the mesh, that is, 1-bit data. For example, when the pieces of map data of the meshes M₄₆, M₅₅, M₅₆, M₆₅, M₉₄, and M_{D1} are not the latest as illustrated in FIG. 8, “1” is stored in each of addresses of “46”, “55”, “56”, “65”, “94” and “D1”, whereas “0” is stored in each of addresses corresponding to IDs of the other meshes (meshes with the pieces of latest map data) as illustrated in FIG. 9. “0” or a null value may be stored in an address corresponding to a mesh without any piece of map data.

Expressing the piece of update necessity data of each mesh in one bit in this manner can reduce the storage capacity of the update necessity data storage unit 15 and reduce the required memory resources. This can also shorten the speed of reading and writing the piece of update necessity data. If a cache memory of a system-on-a-chip (SoC) is used as the update necessity data storage unit 15, the processes can be further accelerated.

Once identifying update-necessary meshes, the map update controller 13 determines whether the pieces of map data of the update-necessary meshes can be updated before the map application 23 requests the pieces of map data of the update-necessary meshes. The map update controller 13 can make this determination based on, for example, a distance from the subject vehicle to an update-necessary mesh, a traveling speed of the subject vehicle, or a download speed of the pieces of update map data. Being capable and incapable of updating the pieces of map data of the update-necessary meshes before the map application 23 requests the pieces of map data of the update-necessary meshes may be hereinafter referred to as “the pieces of map data are updated in time” and “the pieces of map data are not updated in time”, respectively.

When determining that the pieces of map data of the update-necessary meshes can be updated (the pieces of map data are updated in time) before the map application 23 requests the pieces of map data of the update-necessary meshes, the map update controller 13 performs a first map update process of immediately updating the pieces of map data of the update-necessary meshes with the pieces of update map data downloaded by the update map data obtaining unit 14 from the map distribution server 30. When the map update controller 13 determines to be incapable of updating the pieces of map data of the update-necessary meshes (the pieces of map data are not updated in time) before the map application 23 requests the pieces of map data of the update-necessary meshes, the map update controller 13 performs a second map update process of updating the pieces of map data of the update-necessary meshes at the timing that an operation of the map application 23 satisfies a predefined condition. This predefined condition will be hereinafter referred to as a “second map update process implementation condition”.

Examples of the second map update process implementation condition include:
(a) end of an operation of the map application 23;
(b) start of the next operation of the map application 23;
(c) the fact that all the pieces of map data being used by the map application 23 have become the latest; and
(d) the fact that the map application 23 has released the pieces of map data.
   The second map update process implementation condition may be satisfying one of such a plurality of conditions.

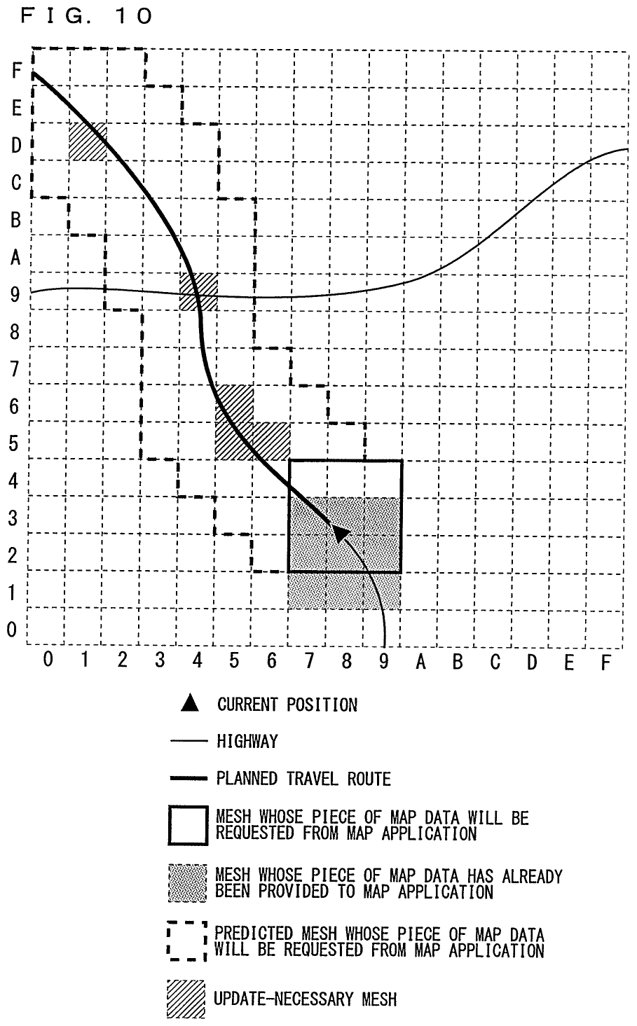

For example, when identifying the mesh M₄₆ as an update-necessary mesh as illustrated in FIG. 8 and determining that the piece of map data of the mesh M₄₆ is updated in time, the map update controller 13 performs the first map update process of immediately updating the piece of map data of the mesh M₄₆. Consequently, the piece of map data of the mesh M₄₆ has become the latest, and the mesh M₄₆ is not an update-necessary mesh as illustrated in FIG. 10 (the piece of update necessity data of the mesh M₄₆ which is stored in the update necessity data storage 15 is rewritten to “0”).

Once identifying a plurality of update-necessary meshes, the map update controller 13 should perform the first map update process on the pieces of map data of the update-necessary meshes in order of increasing proximity from a starting mesh toward a traveling direction. The starting mesh is the farthest one of the meshes whose pieces of map data have been provided to the map application 23, from the current position of the subject vehicle toward the traveling direction (e.g., M₃₇ in FIG. 8). This can reduce the probability of occurrence of a mesh whose piece of map data is not updated in time.

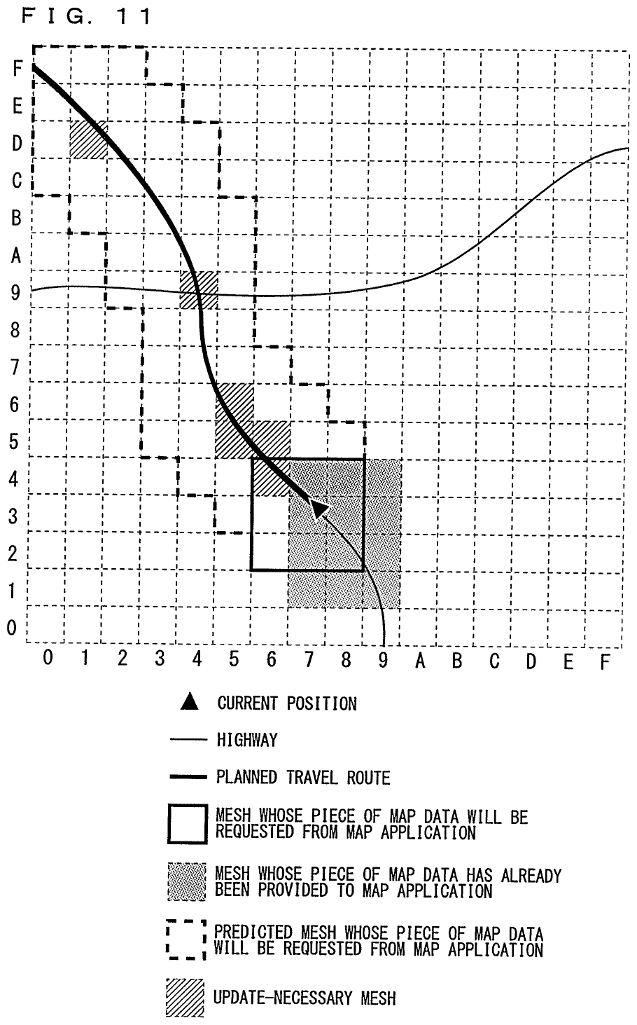

When determining that the piece of map data of the mesh M₄₆ is not updated in time, the map update controller 13 suspends an update of the piece of map data of the mesh M₄₆ and determines to update the piece of map data of the mesh M₄₆ through the second map update process. Here, the map application 23 requests the piece of map data of the mesh M₄₆ which remains as an update-necessary mesh as illustrated in FIG. 11. Thus, the map application 23 is provided with the piece of map data of the mesh M₄₆ in an old version.

Once determining to update the piece of map data of any mesh through the second map update process, the map update controller 13 does not resume the first map update process until actually performing the second map update process. This reason is shown in an example in FIG. 8 where the piece of map data of the mesh M₄₆ is not updated in time, whereas the piece of map data of the mesh M₅₆ is probably updated in time. Here, if the map update controller 13 performs the second map update process on the piece of map data of the mesh M₄₆ and the first map update process on the piece of map data of the mesh M₅₆, the map application 23 is unfortunately provided with the piece of old map data mixed with the piece of latest map data.

Once identifying a plurality of update-necessary meshes, the map update controller 13 determines whether the pieces of map data of all the update-necessary meshes are updated in time. When determining that the piece of map data of one of the update-necessary meshes is not updated in time, the map update controller 13 preferably performs the second map update process on the pieces of map data of all the update-necessary meshes. This reason is shown in an example in FIG. 8 where the piece of map data of the mesh M₄₆ is updated in time, whereas the piece of map data of the mesh M₅₆ is probably not updated in time. Here, if the map update controller 13 performs the first map update process on the piece of map data of the mesh M₄₆ and the second map update process on the piece of map data of the mesh M₅₆, the map application 23 is unfortunately provided with the piece of old map data mixed with the piece of latest map data.

When determining to update the piece of map data of any mesh through the second map update process, the map update controller 13 stores, in the update map data storage 16, a piece of update map data of the update-necessary mesh which has been downloaded by the update map data obtaining unit 14 from the map distribution server 30 until actually performing the second map update process. This operation of the map update controller 13 will be referred to as a “preparation operation of the second map update process”.

Specifically, the map update controller 13 performs the second map update process by overwriting the piece of map data in the map database 11 with the piece of update map data stored in the update map data storage 16 for the preparation operation. When the second map update process is completed, the piece of update map data stored in the update map data storage 16 is unnecessary. Thus, the update map data storage 16 is cleared. In other words, the map update controller 13 performs the second map update process by moving the piece of update map data from the update map data storage 16 to the map database 11.

As such, performing the second map update process using the piece of update map data stored in the update map data storage 16 can omit a process of downloading the piece of update map data from the map distribution server 30 in performing the second map update process, and can shorten the time required for the second map update process.

However, when the pieces of update map data stored in the update map data storage 16 are insufficient for the second map update process, that is, when the update map data storage 16 does not store the pieces of update map data corresponding to all the update-necessary meshes, the map update controller 13 may obtain lacking pieces of update map data from the map distribution server 30.

The map update controller 13 need not always perform the second map update process on all the update-necessary meshes, but may perform the second map update process on meshes in a predefined area including a mesh to which the current position of the subject vehicle belongs. This is because even if an update-necessary mesh remains in a place distant from the subject vehicle, the map update controller 13 can update the piece of map data of the update-necessary mesh through the first map update process.

As such, when the map update controller 13 of the map data management apparatus 10 cannot update pieces of map data of update-necessary meshes in time, the map update controller 13 does not update the pieces of map data of the update-necessary meshes soon, but updates the pieces of map data later when an operation of the map application 23 satisfies the second map update process implementation condition. This consequently prevents mixing a piece of old map data with a piece of latest map data and providing the mixed pieces of map data to the map application 23, and prevents the map application 23 from operating abnormally.

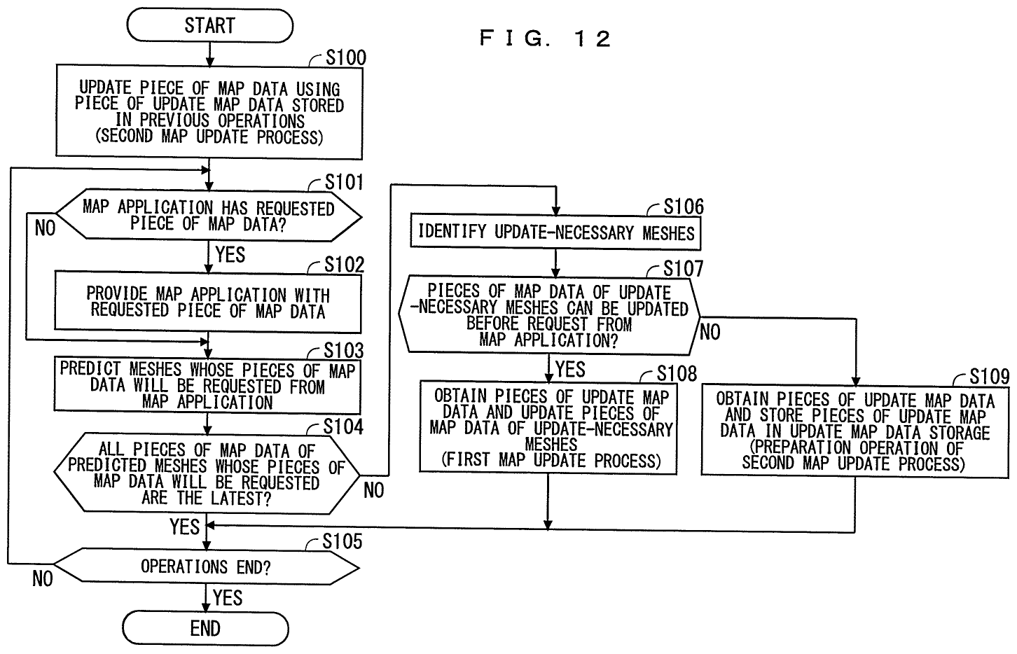

FIG. 12 is a flowchart illustrating operations of the map data management apparatus 10 according to Embodiment 1. The operations of the map data management apparatus 10 will be described with reference to the flowchart in FIG. 12. The procedure in FIG. 12 is an example procedure when the second map update process implementation condition is the start of the next operation of the map application 23 (the aforementioned “b”).

Once the map data management apparatus 10 starts the operations, first, the map update controller 13 updates a piece of map data of a mesh whose update of the piece of map data has been suspended in previous operations, using a piece of update map data stored in the update map data storage 16 in a preparation operation of the second map update process in the previous operations (Step S100). In other words, Step S100 is the second map update process on the piece of map data of the mesh whose update of the piece of map data has been suspended in the previous operations. When the pieces of update map data are not stored in the update map data storage 16 at the end of the previous operations, nothing is performed in Step S100.

Next, the map access unit 12 checks whether the piece of map data has been requested from the map application 23 (Step S101). If the piece of map data has been requested from the map application 23 (YES in Step S101), the map access unit 12 provides the map application 23 with the requested piece of map data by reading the piece of map data from the map database 11 and storing the read piece of map data in the prefetch map data storage 24 (Step S102). If the piece of map data is not requested from the map application 23 (NO in Step S101), Step S102 is not performed.

Next, the map update controller 13 predicts meshes whose pieces of map data will be requested from the map application 23 (Step S103). Then, the map update controller 13 determines whether all the pieces of map data of the predicted meshes whose pieces of map data will be requested from the map application 23 (predicted requested meshes) are the latest (Step S104). If all the pieces of map data of the predicted requested meshes are the latest (YES in Step S104) and the operations of the map data management apparatus 10 do not end by, for example, turning off the engine of the subject vehicle (NO in Step S105), the processes return to Step ST101.

If the predicted requested meshes include meshes whose pieces of map data are not the latest (NO in Step S104), the map update controller 13 identifies the meshes as update-necessary meshes (Step S106). Then, the map update controller 13 determines whether the pieces of map data of the update-necessary meshes can be updated (whether the pieces of map data are updated in time) before the map application 23 requests the pieces of map data of the update-necessary meshes (Step S107).

When determining that the pieces of map data are updated in time (YES in Step S107), the map update controller 13 obtains pieces of update map data from the map distribution server 30 through the update map data obtaining unit 14, and updates the pieces of map data of the update-necessary meshes using the obtained pieces of update map data (Step S108). In other words, Step S108 is the first map update process of immediately updating the pieces of map data of the update-necessary meshes with the pieces of update map data obtained from the map distribution server 30.

When determining that the pieces of map data are not updated in time (NO in Step S107), the map update controller 13 obtains pieces of update map data from the map distribution server 30 through the update map data obtaining unit 14, and stores the obtained pieces of update map data in the update map data storage 16 (Step S109). In other words, Step S109 is a preparation operation of the second map update process of storing, in the update map data storage 16, pieces of update map data downloaded from the map distribution server 30. After determining NO in Step S107 once, the map update controller 13 continues to determine NO in Step S107 until the operations of the map data management apparatus 10 end, to prevent mixing a piece of old map data with a piece of latest map data and providing the mixed pieces of map data to the map application 23.

Then, the processes proceed to Step S105. If the operations of the map data management apparatus 10 do not end (NO in Step S105), the processes return to Step ST101.

[Modifications]

The map update controller 13 need not always resume the first map update process soon after performing the second map update process. For example, when there are many update-necessary meshes around the subject vehicle and prospects for resuming the first map update process are nil, the map update controller 13 may continue the preparation operation of the second map update process without resuming the first map update process. Furthermore, when the processing load of the map data management apparatus 10 is high and resources for the CPU and the memory are insufficient, or when the communication rate with the map distribution server 30 decreases, the map update controller 13 may continue the preparation operation of the second map update process without resuming the first map update process.

The map update controller 13 need not always perform the second map update process soon when the second map update process implementation condition is satisfied. For example, when the map application 23 guides a route for the subject vehicle, the map update controller 13 may continue the preparation operation of the second map update process until the map application 23 finishes the guidance. The map update controller 13 may perform the second map update process when the map application 23 finishes the guidance. When the map application 23 finishes using the piece of map data immediately after the second map update process implementation condition is satisfied, the map update controller 13 should perform the second map update process at the timing that the map application 23 resumes using the piece of map data.

The map data management apparatus 10 may notify, through a display, the user of whether the piece of latest map data has been supplied or the piece of old map data before an update has been provided to the map application 23. Consequently, when the map application 23 does not operate normally, the user can determine whether the piece of map data is the cause.

FIG. 8 illustrates an example where the map update controller 13 predicts meshes whose pieces of map data will be requested from the map application 23, based on a planned travel route of the subject vehicle. When the planned travel route of the subject vehicle is not set, the map update controller 13 may predict a route through which the subject vehicle will travel, and predict meshes in a predefined area which include meshes to which the predicted route belongs, as the meshes whose pieces of map data will be requested from the map application 23. Examples of a method for predicting a route through which the subject vehicle will travel include a method for predicting the route from traveling records of the subject vehicle, and a method for predicting that the subject vehicle will continue to travel through a road along which the subject vehicle is currently traveling without changing the road.

The positioning unit 22 of the in-vehicle apparatus 20 may correct a current position of the subject vehicle through map-matching per lane using pieces of high-definition map data (HD map data). This improves the positioning accuracy of the position of the subject vehicle. When the position of the subject vehicle before correction does not match that on a lane, the positioning unit 22 may implement map-matching based on a road shape. The pieces of HD map data to be used for the map-matching may be obtained from the map database 11 of the map data management apparatus 10 or from the map distribution server 30.

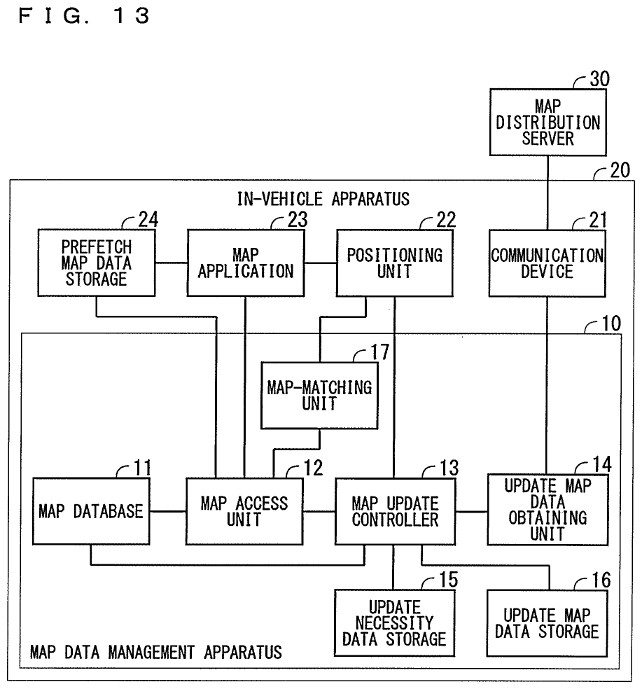

The map-matching may be implemented inside the map data management apparatus 10. FIG. 13 illustrates a configuration of the map data management apparatus 10 including a map-matching unit 17 that implements map-matching per lane. The map-matching unit 17 implements map-matching to correct a current position of the subject vehicle which has been calculated by the positioning unit 22 from a positioning signal of GNSS or sensor information of the subject vehicle, and enters the resulting position into the map access unit 12.

The map data management apparatus 10 may provide the map application 23 with information indicating the presence or absence of pieces of HD map data of a road along which the subject vehicle is traveling. The map application 23 may change an operation, depending on the presence or absence of the pieces of HD map data of the road along which the subject vehicle is traveling.

Embodiment 1 is effective when the pieces of map data stored in the map database 11 are pieces of high-definition map data (HD map data) requiring relatively a long time for an update. The pieces of map data may be pieces of standard map data (may be hereinafter referred to as “SD map data”) including road shape information for each road.

Furthermore, when the update map data storage 16 does not have a sufficient free capacity and a piece of update map data of an update-necessary mesh newly identified cannot be stored in the update map data storage 16, the map update controller 13 in performing the preparation operation of the second map update process may determine a priority of the newly identified update-necessary mesh and priorities of update-necessary meshes corresponding to pieces of update map data already stored in the update map data storage 16, and select pieces of update map data to be stored in the update map data storage 16 so that pieces of update map data of update-necessary meshes with higher priorities are stored in the update map data storage 16. Specifically, when the pieces of update map data already stored in the update map data storage 16 include pieces of update map data of update-necessary meshes with priorities lower than that of the newly identified update-necessary mesh, the map update controller 13 may delete a piece of update map data of an update-necessary mesh with a lower priority (e.g., an update-necessary mesh with the lowest priority) among those of the update-necessary meshes to increase the free capacity of the update map data storage 16, and then store the piece of update map data of the newly identified update-necessary mesh in the update map data storage 16. When the pieces of update map data already stored in the update map data storage 16 do not include pieces of update map data of update-necessary meshes with priorities lower than that of the newly identified update-necessary mesh, the map update controller 13 may maintain the pieces of update map data already stored in the update map data storage 16 without downloading the piece of update map data of the newly identified update-necessary mesh.

Examples of a method for determining a priority of an update-necessary mesh include a method for determining that a priority of an update-necessary mesh is higher as the mesh is closer to the subject vehicle, a method for determining that a priority of an update-necessary mesh is higher as the mesh is closer to a particular point of interest (POI) such as a home of the user, and a method for determining that a priority of an update-necessary mesh is higher as its map data is more frequently used by a map application. Here, a priority of an update-necessary mesh represents a priority of a piece of update map data of the update-necessary mesh. Thus, for example, “a piece of update map data of an update-necessary mesh with a lower priority” can be read as “a piece of update map data with a lower priority”.

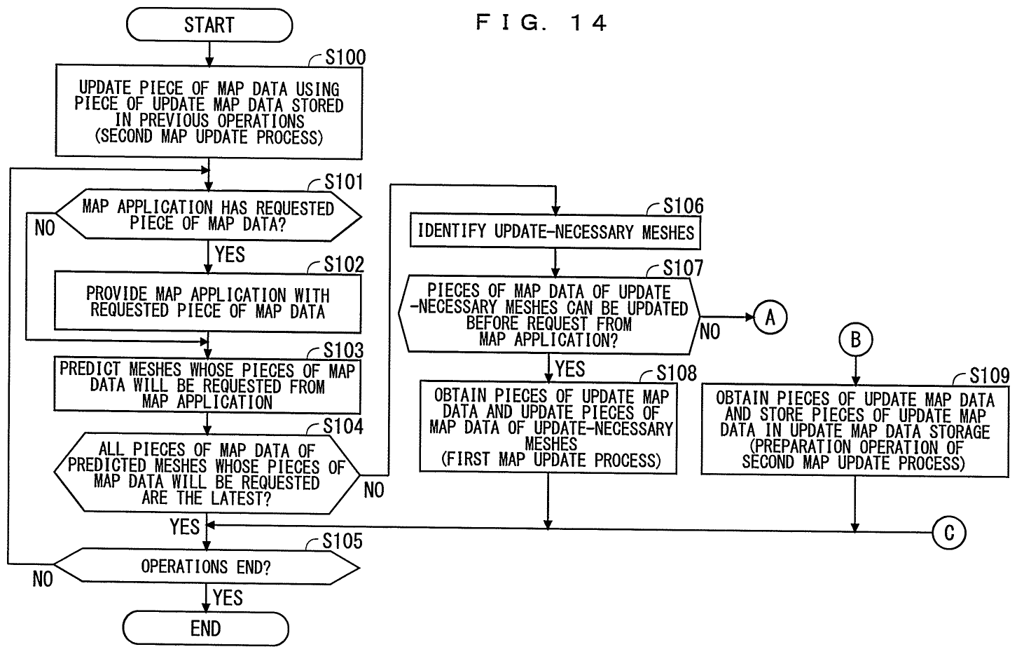

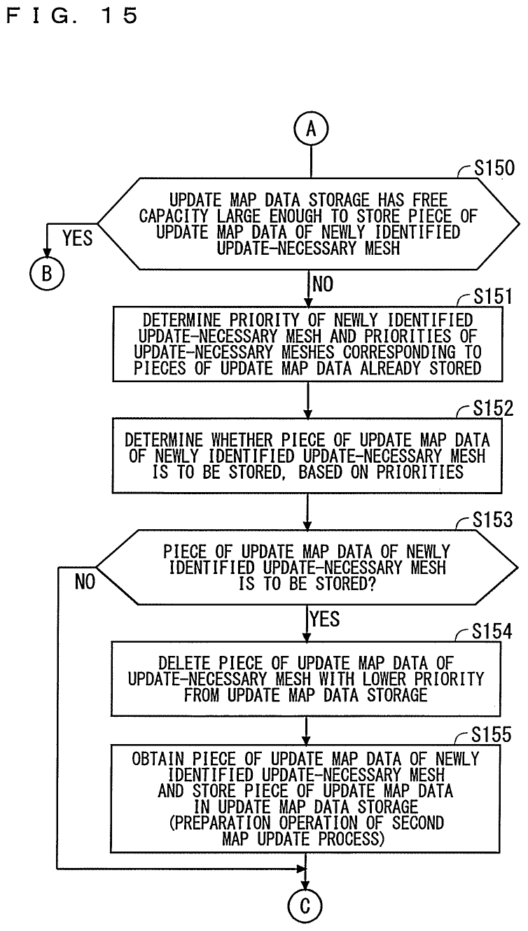

FIGS. 14 and 15 are flowcharts illustrating operations of the map data management apparatus 10 when the map update controller 13 selects a piece of update map data to be stored in the update map data storage 16. The procedure in FIGS. 14 and 15 is a procedure obtained by adding Steps S150 to S155 in FIG. 15 to the procedure in FIG. 12. Since the other steps are the same as those in the procedure in FIG. 12, the description will be omitted.

In the procedure in FIGS. 14 and 15, when determining that the pieces of map data are not updated in time (NO in Step S107), the map update controller 13 accesses the map distribution server 30, checks the size of a piece of update map data of an update-necessary mesh newly identified, and checks whether the update map data storage 16 has a free capacity large enough to store the piece of update map data of the newly identified update-necessary mesh (Step S150). When the update map data storage 16 has the free capacity large enough to store the piece of update map data of the newly identified update-necessary mesh (YES in Step S150), the processes proceed to Step S109. The map update controller 13 obtains the piece of update map data from the map distribution server 30 through the update map data obtaining unit 14, and stores the obtained piece of update map data in the update map data storage 16.

When the update map data storage 16 does not have the free capacity large enough to store the piece of update map data of the newly identified update-necessary mesh (NO in Step S150), the map update controller 13 determines a priority of the newly identified update-necessary mesh and priorities of update-necessary meshes corresponding to pieces of update map data already stored in the update map data storage 16 (Step S151). Then, the map update controller 13 determines whether the piece of update map data of the newly identified update-necessary mesh is to be stored in the update map data storage 16, based on the priorities of the update-necessary meshes (Step S152). Specifically, the map update controller 13 determines that the piece of update map data of the newly identified update-necessary mesh is to be stored in the update map data storage 16 when the pieces of update map data already stored in the update map data storage 16 include pieces of update map data with priorities lower than that of the newly identified update-necessary mesh. Otherwise, the map update controller 13 determines that the piece of update map data of the newly identified update-necessary mesh is not to be stored in the update map data storage 16.

Consequently, when determining that the piece of update map data of the newly identified update-necessary mesh is to be stored (YES in Step S153), the map update controller 13 deletes a piece of update map data with a lower priority from the pieces of update map data already stored in the update map data storage 16 to increase the free capacity of the update map data storage 16 (Step S154). The piece of update map data to be deleted is lower in priority than the piece of update map data of the newly identified update-necessary mesh, and may be, for example, a piece of update map data with the lowest priority.

Then, the map update controller 13 obtains the piece of update map data of the newly identified update-necessary mesh from the map distribution server 30, and stores the piece of update map data in the update map data storage 16 (Step S155). In other words, Step S155 is a preparation operation of the second map update process of storing, in the update map data storage 16, the piece of update map data downloaded from the map distribution server 30. After Step S155, the processes proceed to Step S105.

When determining that the piece of update map data of the newly identified update-necessary mesh is not to be stored (NO in Step S153), Steps S154 and S155 are skipped and the processes proceed to Step S105. Specifically, in this case, the map update controller 13 does not download the piece of update map data of the newly identified update-necessary mesh, and maintains the pieces of update map data already stored in the update map data storage 16.

### Embodiment 2

Maintenance of pieces of high-definition map data (HD map data) is on the way from pieces of map data of, for example, highways and major roads, and will gradually proceed to those of general highways. Thus, the pieces of HD map data often exist only in meshes including highways and major roads under present circumstances. Embodiment 2 proposes the map data management apparatus 10 that predicts meshes whose pieces of map data will be requested from the map application 23, with attention being given to such features of the pieces of HD map data.

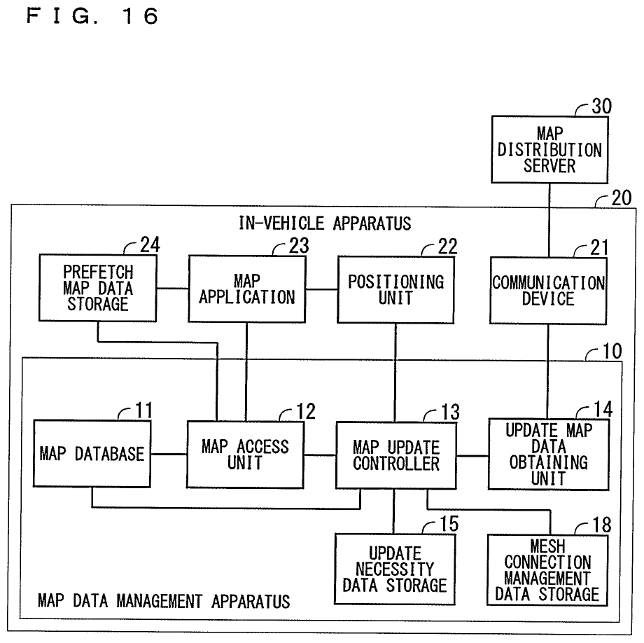

FIG. 16 is a block diagram illustrating a configuration of the map data management apparatus 10 according to Embodiment 2. The configuration of the map data management apparatus 10 in FIG. 16 is obtained by replacing the update map data storage 16 with a mesh connection management data storage 18 in the configuration of FIG. 1. In Embodiment 2, the pieces of map data stored in the map database 11 are also pieces of HD map data.

The mesh connection management data storage 18 is a storage medium storing a piece of mesh connection management data that is data indicating whether a piece of HD map data exists in each mesh. In Embodiment 2, the map update controller 13 accesses the map distribution server 30 in advance (e.g., when the map data management apparatus 10 is started) to check in which mesh the piece of HD map data exists, and stores, in the mesh connection management data storage 18, the result as a piece of mesh connection management data. Storing, in advance, the piece of mesh connection management data in the mesh connection management data storage 18 can reduce the number of times the map update controller 13 accesses the map distribution server 30 to check the presence or absence of a piece of HD map data in each mesh, and accelerate the processes.

Although the number of times the map update controller 13 accesses the map distribution server 30 is increased, the map update controller 13 may access the map distribution server 30 to check the presence or absence of a piece of HD map data in each mesh, each time the presence or absence of a piece of HD map data needs to be checked. In such a case, the mesh connection management data storage 18 is unnecessary.

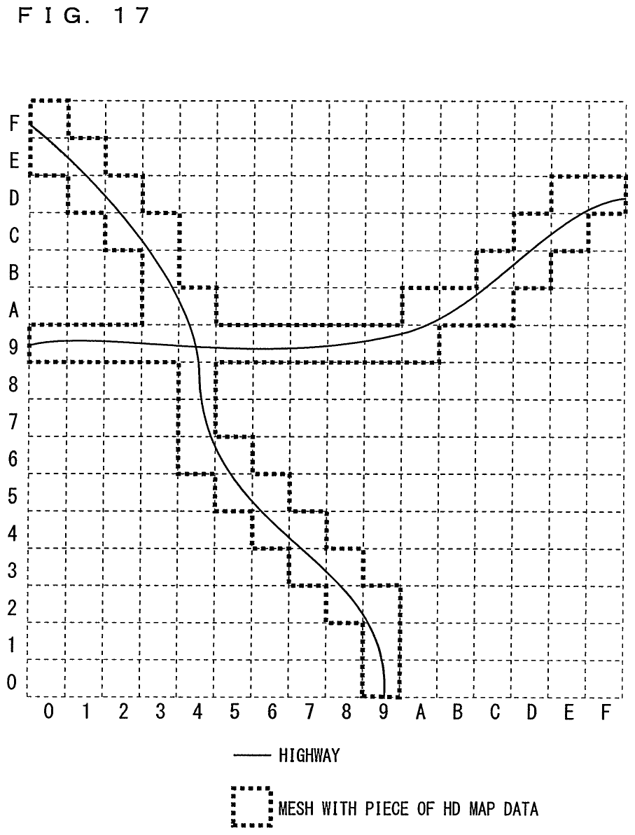

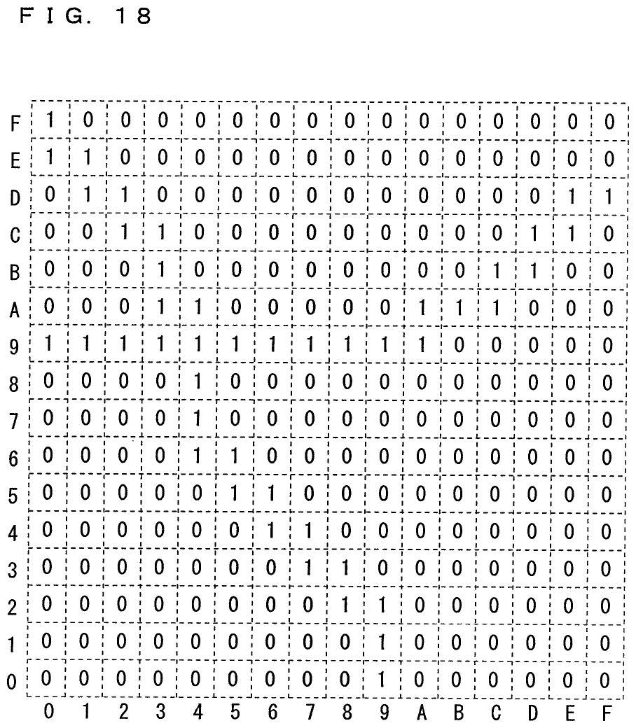

For example, when the map in FIG. 17 includes pieces of HD map data only in meshes including highways (meshes enclosed by thick dotted lines), the pieces of mesh connection management data as illustrated in, for example, FIG. 18 are stored in the mesh connection management data storage 18. The piece of mesh connection management data in FIG. 18 is a flag stored in an address corresponding to an ID of each mesh, that is, 1-bit data. “1” is stored in an address corresponding to an ID of a mesh with a piece of HD map data, whereas “0” is stored in an address corresponding to an ID of a mesh without a piece of HD map data.

Expressing the piece of mesh connection management data corresponding to each mesh in one bit in this manner can reduce the storage capacity of the mesh connection management data storage 18 and reduce the required memory resources. This can also shorten the speed of reading and writing the piece of mesh connection management data. If a cache memory of a system-on-a-chip (SoC) is used as the mesh connection management data storage 18, the processes can be further accelerated.

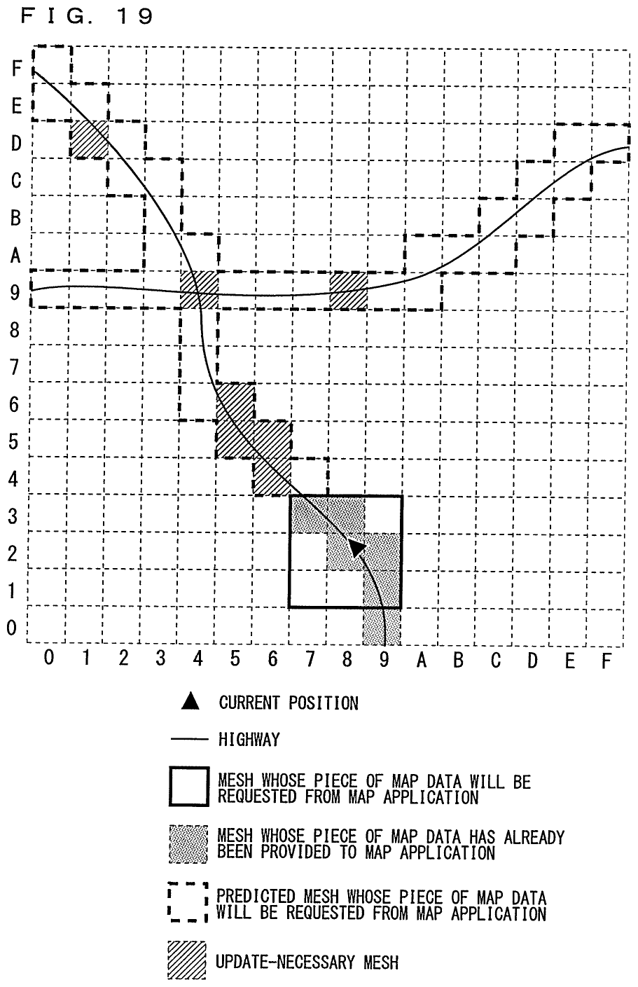

Embodiment 2 differs from Embodiment 1 in the operations of the map update controller 13. The map update controller 13 in Embodiment 2 predicts meshes with pieces of HD map data that are connected from a mesh to which the current position of the subject vehicle belongs, as the meshes whose pieces of map data will be requested from the map application 23. For example, when the position of the subject vehicle is a mesh M₂₈ as illustrated in FIG. 19, the map update controller 13 predicts, as the meshes whose pieces of map data will be requested from the map application 23, meshes in a mesh area (an area enclosed by thick broken lines) with pieces of HD map data which are connected from the mesh M₂₈. In FIG. 19, the map update controller 13 predicts, as the meshes whose pieces of map data will be requested, only meshes ahead of a traveling direction of the subject vehicle.

The map update controller 13 can accelerate a process of checking the connection of meshes with pieces of HD map data, with reference to the pieces of mesh connection management data stored in the mesh connection management data storage 18.

Once predicting the meshes whose pieces of map data will be requested from the map application 23, the map update controller 13 identifies meshes whose pieces of map data stored in the map database 11 are not the latest as update-necessary meshes, from among the predicted meshes whose pieces of map data will be requested (predicted requested meshes). FIG. 19 illustrates an example where meshes M₄₆, M₅₅, M₅₆, M₆₅, M₉₄, M₉₈, and M_{D1} are determined as update-necessary meshes from among the predicted requested meshes (meshes in the area enclosed by the thick broken lines).

Similarly to Embodiment 1, the map update controller 13 can determine at a high speed whether the piece of map data of each mesh stored in the map database 11 is the latest, with reference to the pieces of update necessity data stored in the update necessity data storage 15.

Once identifying the update-necessary meshes, the map update controller 13 obtains pieces of update map data of the update-necessary meshes from the map distribution server 30 through the update map data obtaining unit 14, and updates the pieces of map data of the update-necessary meshes.

Consequently, the map update controller 13 performs a process of predicting meshes whose pieces of map data will be requested from the map application 23 in a simple method based on the connection of meshes with pieces of HD map data, and excludes meshes without any piece of HD map data from meshes to be predicted in Embodiment 2. Thus, the map update controller 13 can predict meshes whose pieces of map data will be requested from the map application 23 and identify update-necessary meshes at a high speed. This reduces the probability of failing to update pieces of map data in time. This consequently prevents mixing a piece of old map data with a piece of latest map data and providing the mixed pieces of map data to the map application 23, and prevents the map application 23 from operating abnormally.

Once identifying a plurality of update-necessary meshes, the map update controller 13 should update the pieces of map data of the update-necessary meshes in order of increasing proximity from a starting mesh toward a traveling direction. The starting mesh is the farthest one of the meshes whose pieces of map data have been provided to the map application 23, from the current position of the subject vehicle toward the traveling direction (e.g., M₃₇ in FIG. 19). This can further reduce the probability of occurrence of a mesh whose piece of map data is not updated in time.

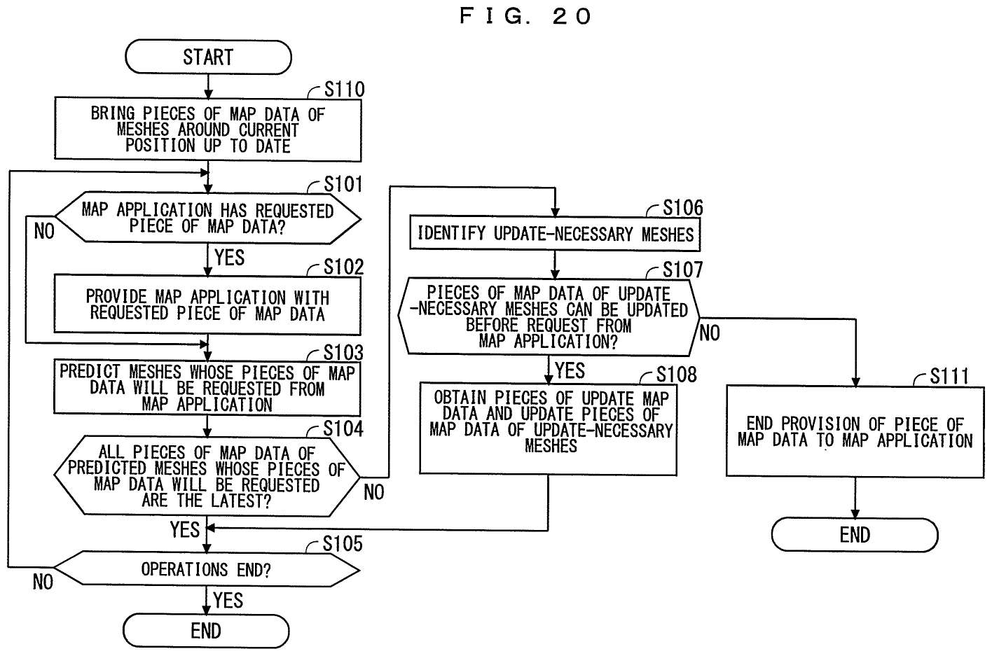

FIG. 20 is a flowchart illustrating operations of the map data management apparatus 10 according to Embodiment 2. The procedure in FIG. 20 is obtained by replacing Step S100 and Step S109 in the procedure in FIG. 12 with Step S110 and Step S111, respectively. Since the other steps are the same as those in the procedure in FIG. 12, the description will be omitted (the operation of the map update controller 13 of predicting meshes whose pieces of map data will be requested from the map application 23 in Step S103 is described above).

Step S110 is performed when the map data management apparatus 10 starts the operations. In Step S110, the map update controller 13 brings pieces of map data of meshes around the current position of the subject vehicle up to date. This process is a preprocess for preventing a failure of updating the pieces of map data in time immediately after the map data management apparatus 10 starts the operations, and may be a process identical to that in updating pieces of map data in a general map database.

Step S111 is performed when the pieces of map data are not updated in time, that is, when NO is determined in Step S107. Step S111 is a process of ending provision of a piece of map data to the map application 23 for preventing provision of a piece of old map data to the map application 23. Since the map update controller 13 predicts meshes whose pieces of map data will be requested from the map application 23 and identifies update-necessary meshes at a high speed, the probability of failing to update pieces of map data in time is low. Thus, the probability of executing Step S111 is also low.

[Modifications]

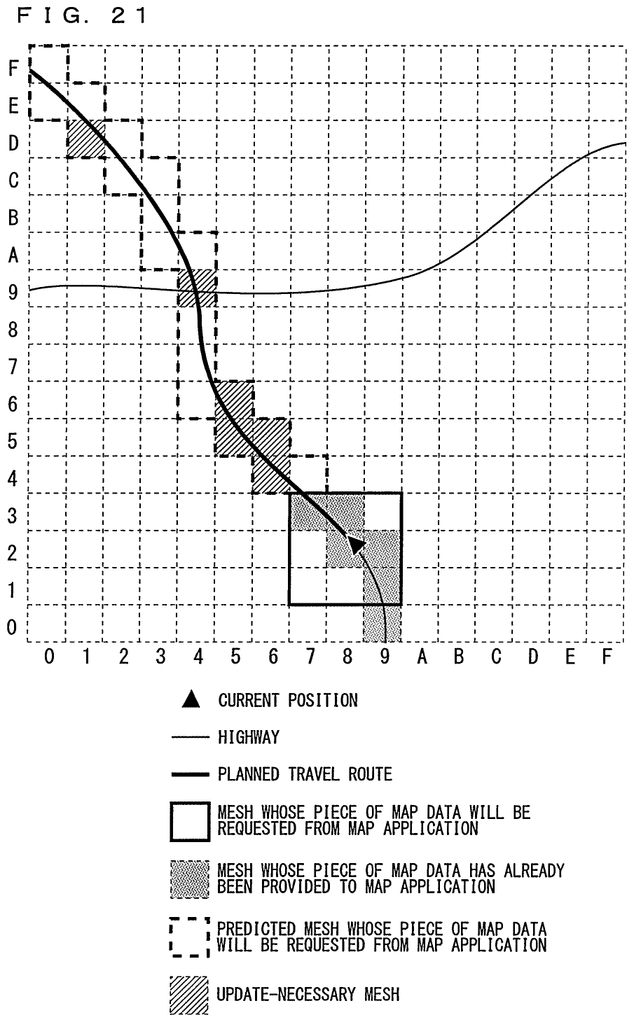

Although FIG. 19 illustrates an example where the planned travel route of the subject vehicle is not set, the map update controller 13 may predict, when the planned travel route is set, meshes with pieces of HD map data in a predefined area relative to a planned travel route, as the meshes whose pieces of map data will be requested from the map application 23 (predicted requested meshes) as illustrated in FIG. 21.

Furthermore, although the map update controller 13 in Embodiment 2 predicts meshes with pieces of HD map data that are connected from a mesh to which the current position of the subject vehicle belongs as the predicted requested meshes, the map update controller 13 may further identify the predicted requested meshes by further taking the connection of roads into account. Specifically, the map update controller 13 may predict, as the predicted requested meshes, meshes with pieces of HD map data of roads that are connected from a road in a mesh to which the current position of the subject vehicle belongs. This can exclude, from the predicted requested meshes, meshes only including roads that are not connected from the road in the mesh to which the subject vehicle belongs. Thus, the processes can be further accelerated.

When the connection of roads is taken into account, a piece of mesh connection management data indicating a connectivity relationship between roads in each mesh may be stored in the mesh connection management data storage 18. For example, a piece of mesh connection management data of each mesh may be 4-bit data indicating to which road in which one of four front, back, left, and right (north, south, east, and west) meshes a road in a mesh is connected. For example, the piece of mesh connection management data of a mesh (e.g., a mesh M₈₄ in FIG. 17) in a road to be connected to front and back meshes can be represented by “1100”, the piece of mesh connection management data of a mesh (e.g., a mesh M₉₃ in FIG. 17) in a road to be connected to left and right meshes can be represented by “0011”, and the piece of mesh connection management data of a mesh (e.g., a mesh M₉₄ in FIG. 17) in a road to be connected to all front, back, left, and right meshes can be represented by “1111”.

When a road that is connected from a road in a mesh to which the current position belongs has a branching point and a traveling direction of the subject vehicle at the branching point is not certain, the map update controller 13 in predicting meshes whose pieces of map data will be requested from the map application 23 should search for, from the branching point to each branching direction, meshes with pieces of high-definition map data that are connected from the mesh to which the current position belongs or meshes with pieces of high-definition map data of roads that are connected from the road in the mesh to which the current position belongs.

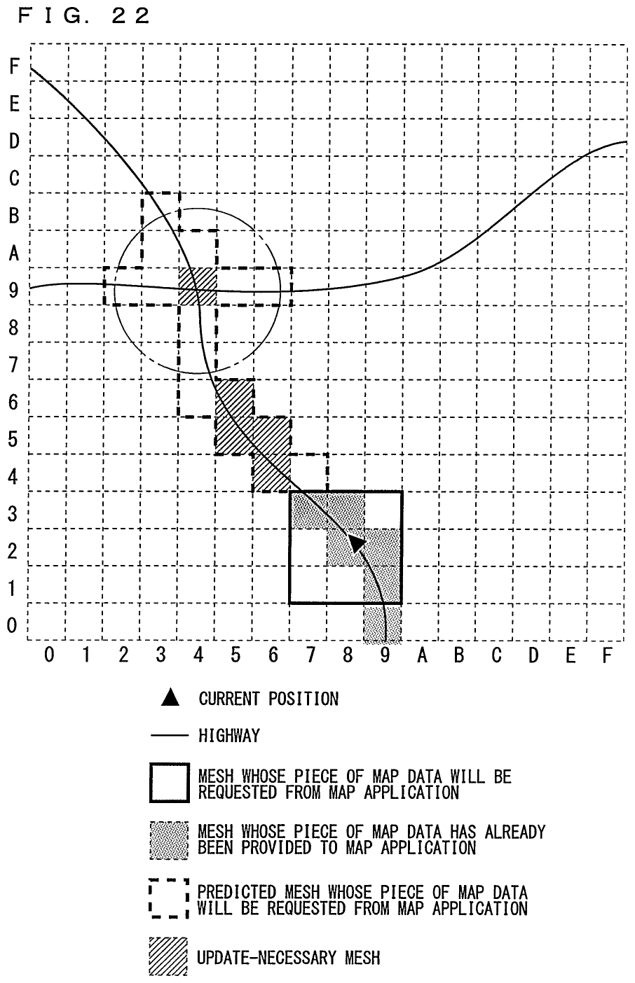

As illustrated in FIG. 22, limiting an area from which the map update controller 13 searches for meshes to meshes at a certain distance from the branching point (within a circle in FIG. 22) can reduce an increase in the processing load. The area from which the map update controller 13 searches for need not be circular. For example, the map update controller 13 may find a direction in which the subject vehicle will highly probably proceed from traveling records of the subject vehicle, and search for meshes farther in the obtained direction with the high probability than in other directions. The map update controller 13 may determine a direction with a particular POI such as a home of the driver of the subject vehicle as a direction in which the subject vehicle will highly probably proceed.

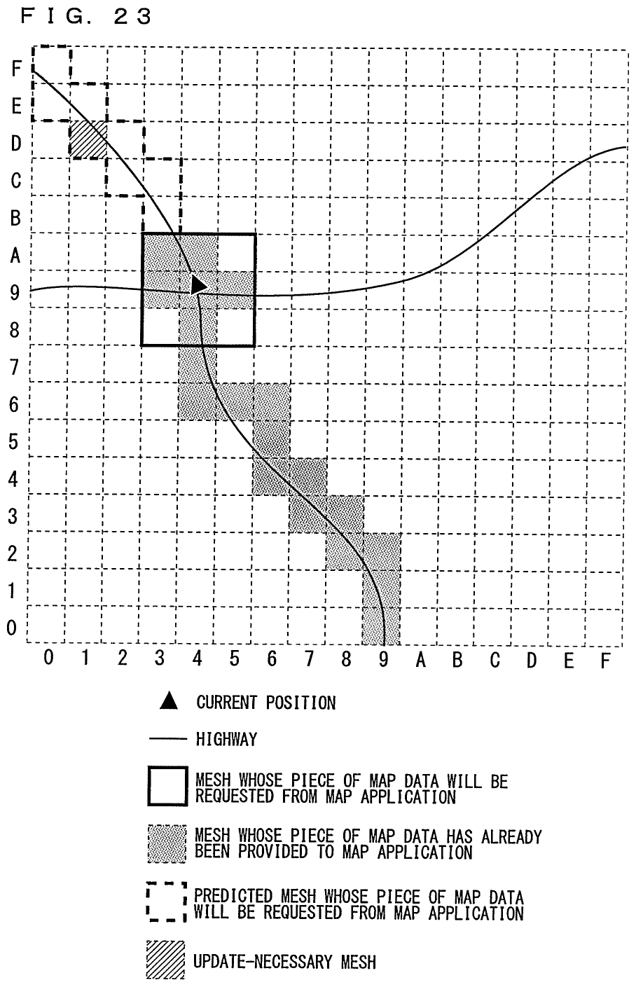

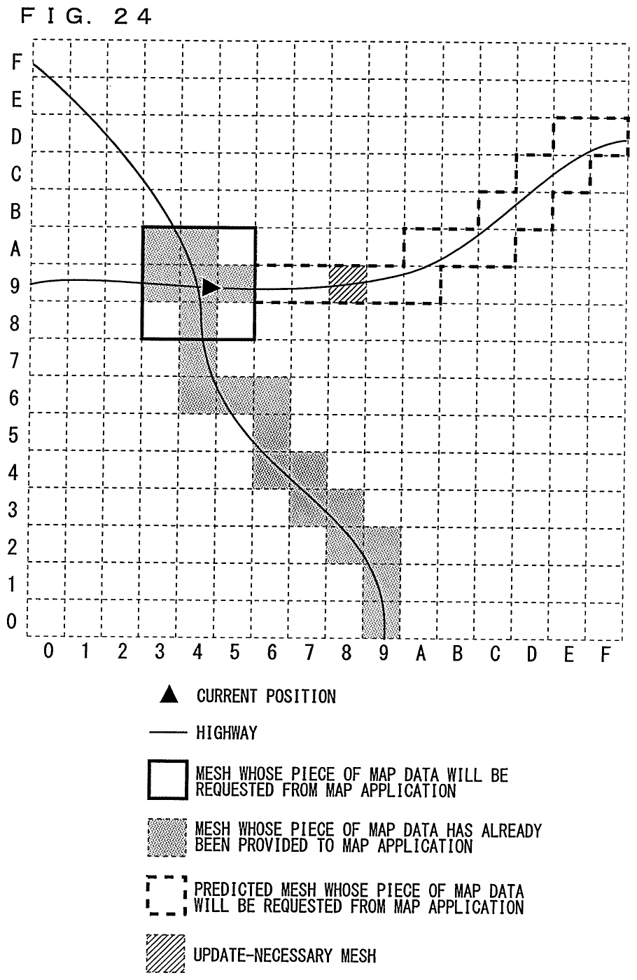

After the subject vehicle has passed the branching point and the traveling direction of the subject vehicle at the branching point becomes certain, the map update controller 13 predicts meshes whose pieces of map data will be requested from the map application 23 by searching for, from the branching point toward the traveling direction, meshes with pieces of high-definition map data that are connected from the mesh to which the current position belongs or meshes with pieces of high-definition map data of roads that are connected from the road in the mesh to which the current position belongs. For example, when the subject vehicle proceeds straight ahead to the north from the state in FIG. 22, the map update controller 13 searches for, from the branching point to the north, meshes to be predicted as the meshes whose pieces of map data will be requested from the map application 23 as illustrated in FIG. 23. Consequently, the map update controller 13 identifies the mesh M_{D1} as an update-necessary mesh. Furthermore, when the subject vehicle turns right to the east at the branching point, the map update controller 13 searches for, from the branching point to the east, meshes to be predicted as the meshes whose pieces of map data will be requested from the map application 23 as illustrated in FIG. 24. Consequently, the map update controller 13 identifies the mesh M₉₈ as an update-necessary mesh. Here, omitting a search in directions different from the traveling direction reduces an increase in the processing load.

### Embodiment 3

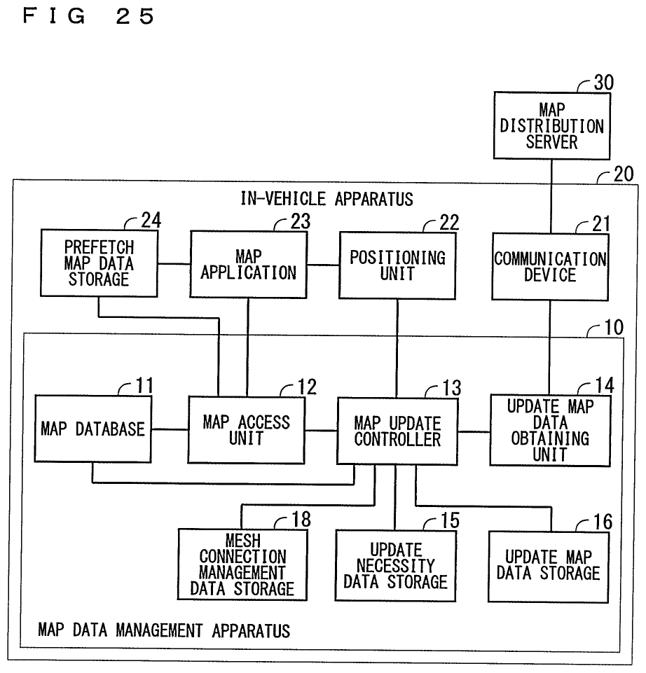

Embodiment 3 will describe an example in which Embodiments 1 and 2 are combined. FIG. 25 is a block diagram illustrating a configuration of the map data management apparatus 10 according to Embodiment 3. The configuration of the map data management apparatus 10 in FIG. 25 is obtained by adding the mesh connection management data storage 18 to the configuration of FIG. 1. In Embodiment 3, the pieces of map data stored in the map database 11 are also pieces of HD map data.

In Embodiment 3, the map update controller 13 predicts meshes whose pieces of map data will be requested from the map application 23 in the method according to Embodiment 2 (the method based on the connection of meshes with pieces of HD map data), and updates the pieces of map data of the update-necessary meshes in the method according to Embodiment 1 (the method performing the first map update process and the second map update process).

The operations of the map data management apparatus 10 according to Embodiment 3 can be represented by a procedure identical to that in FIG. 12 according to Embodiment 1. In Embodiment 3, however, Step S103 of predicting meshes whose pieces of map data will be requested from the map application 23 is performed in the method according to Embodiment 2.

Embodiment 3 can produce both of an advantage of reducing the probability of failing to update the pieces of map data in time in Embodiment 2, and an advantage of preventing mixing a piece of old map data with a piece of latest map data and providing the mixed pieces of map data to the map application 23 by performing the second map update process when the pieces of map data are not updated in time in Embodiment 1.

### Embodiment 4

The map data management apparatus 10 in each of Embodiments 1 to 3 manages the pieces of HD map data or the pieces of SD map data. Embodiment 4 will describe an example of the map data management apparatus 10 that manages both of the pieces of HD map data and the pieces of SD map data.

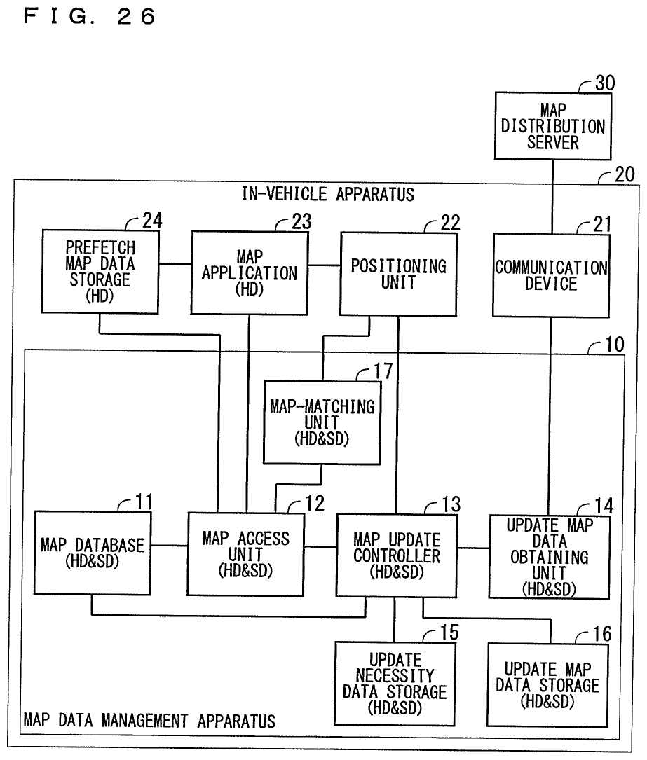

FIG. 26 illustrates a configuration of the map data management apparatus 10 according to Embodiment 4. The configuration of the map data management apparatus 10 according to Embodiment 4 is identical to that in FIG. 13 illustrated as the modification of Embodiment 1. Each of the constituent elements of the map data management apparatus 10 is configured to correspond to two types of map data, namely, pieces of SD map data and pieces of HD map data.

For example, the map database 11 stores a piece of HD map data and a piece of SD map data per mesh. The update map data storage 16 stores a piece of update map data for updating the piece of HD map data, and a piece of update map data for updating the piece of SD map data. The map access unit 12 can read both of the piece of HD map data and the piece of SD map data from the map database 11, and provide the map application 23 with the piece of HD map data and provide the map-matching unit 17 with the piece of HD map data and the piece of SD map data.

Each of the constituent elements of the map data management apparatus 10 manages the piece of HD map data and the piece of SD map data as respective different files. An area of meshes with pieces of HD map data is identical to that of meshes with pieces of SD map data.

The operations of the map data management apparatus 10 according to Embodiment 4 are basically identical to those according to the modifications of Embodiment 1. Meanwhile, the map data management apparatus 10 according to Embodiment 4 transmits, to the map application 23, information on whether the subject vehicle is traveling along a road with pieces of HD map data, using the pieces of HD map data and the pieces of SD map data. Hereinafter, a road with pieces of HD map data will be referred to as an “HD road”, whereas a road only with pieces of SD map data will be referred to as an “SD road”.

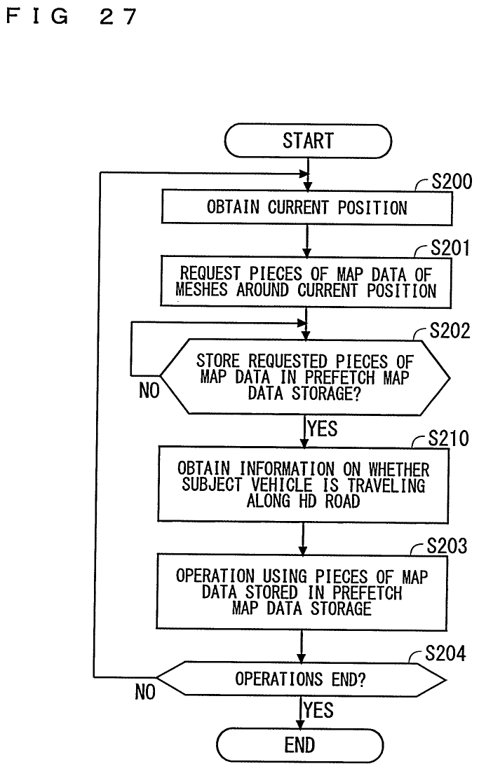

FIG. 27 is a flowchart illustrating operations of the map application 23 according to Embodiment 4. The procedure in FIG. 27 is a procedure obtained by adding Step S210 before Step S203 to the procedure in FIG. 2. In Step S210, the map application 23 obtains, from the map data management apparatus 10, information on whether the subject vehicle is traveling along an HD road.

In Embodiment 4, the operation of the map application 23 in Step S203 is changed according to whether the subject vehicle is traveling along an HD road. For example, the map application 23 executes the ADAS function with pieces of HD map data when the subject vehicle is traveling along an HD road. Otherwise, the map application 23 executes the ADAS function using information from only a perimeter sensor of the subject vehicle.

For example, when the map application 23 is executing lane keeping control by detecting white lines on a road and the subject vehicle is traveling along an HD road, the subject vehicle even with difficulty in detecting the white lines due to an influence of an obstacle or a curve can continue to keep the lane, based on a shape of the lane understood from the pieces of HD map data. When the subject vehicle is not traveling along the HD road, the accuracy of keeping the lane decreases. In such a case, safer control is performed, for example, a traveling speed is reduced.

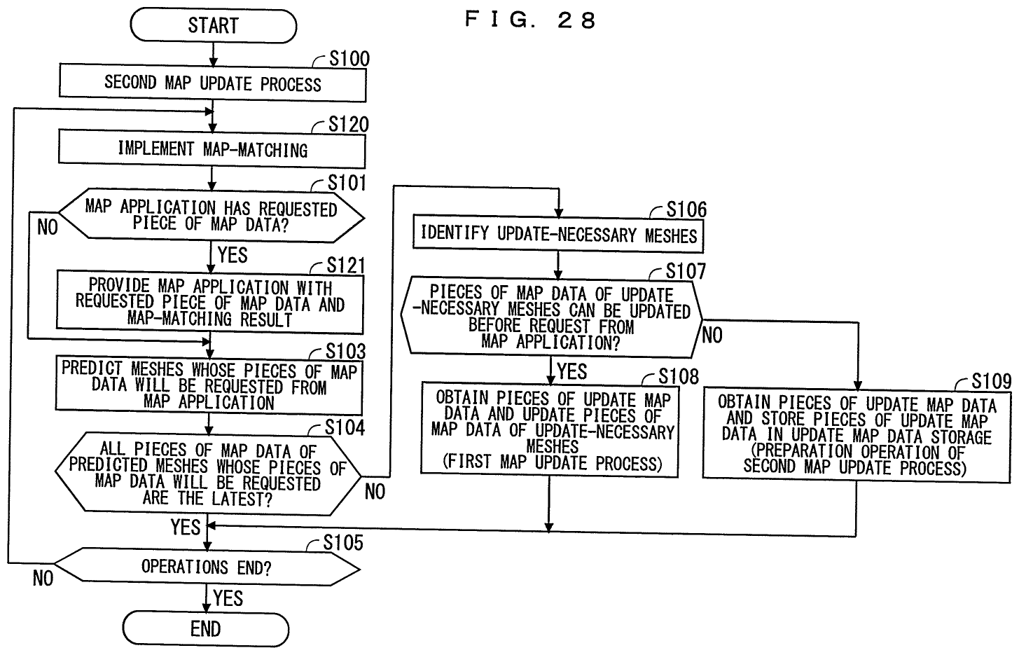

FIG. 28 is a flowchart illustrating operations of the map data management apparatus 10 according to Embodiment 4. The procedure in FIG. 28 is obtained by adding Step S120 and replacing Step S102 with Step S121 in the procedure in FIG. 12.

In Step S120, the map-matching unit 17 implements map-matching on a position of the subject vehicle using the piece of SD map data and the piece of HD map data. When the subject vehicle is traveling along an SD road, that is, along a road without any piece of HD map data, the piece of SD map data can be used for map-matching for detecting a traveling road of the subject vehicle. The detailed description of the map-matching is omitted because a known map-matching method is applicable. For example, Japanese Patent Application Laid-Open No. 2018-96743 discloses a method for determining along which road a subject vehicle is traveling.

In Step S121, the map access unit 12 provides the map application 23 with the piece of map data requested from the map application 23. At the same time, the map-matching unit 17 provides the map application 23 with the map-matching result, that is, information on a road along which the subject vehicle is traveling. The information on the road along which the subject vehicle is traveling includes information on whether the subject vehicle is traveling along an HD road.

The second map update process in Step S100, determination on whether pieces of map data need to be updated in Step S104, the first map update process in Step S108, and the preparation operation of the second map update process in Step S109 are performed on both of the piece of HD map data and the piece of SD map data. Furthermore, Step S103 of predicting meshes whose pieces of map data will be requested from the map application 23 may be performed in the method according to Embodiment 1 (the method based on, for example, a planned travel route of the subject vehicle) or in the method according to Embodiment 2 (the method based on the connection of meshes with pieces of HD map data).

The operation of the map application 23 according to Embodiment 4 can be changed according to whether the subject vehicle is traveling along an HD road. Since the map database 11 stores not only pieces of HD map data but also pieces of SD map data, map-matching can be implemented even when the subject vehicle is traveling along a road without a piece of HD map data. This can also prevent a failure of updating both of the pieces of HD map data and the pieces of SD map data in time.

[Modifications]

Meshes with the pieces of HD map data may be different from those with the pieces of SD map data. For example, one mesh of a piece of HD map data may be identical in width to 3×3 meshes with pieces of SD map data.

An area of meshes in which whether pieces of HD map data need to be updated is checked, that is, an area of meshes whose pieces of HD map data will be requested from the map application 23 may differ from that with pieces of SD map data. For example, an area of meshes in which whether pieces of HD map data need to be updated is checked may be wider than that with pieces of SD map data. Consequently, the map update controller 13 can update the pieces of HD map data in an area of meshes wider than that with the pieces of SD map data. When the subject vehicle is traveling along an HD road, an area of meshes in which whether pieces of HD map data need to be updated is checked may be wider than that with the pieces of SD map data.

The map update controller 13 may update the piece of HD map data more preferentially than the piece of SD map data. For example, when downloading both of the piece of HD map data and the piece of SD map data causes a failure in updating the piece of HD map data in time, the map update controller 13 may perform the first map update process only on the piece of HD map data, and need not perform the second map update process on the piece of SD map data. Alternatively, the map update controller 13 may perform the preparation operation of the second map update process on the piece of SD map data.

Furthermore, when downloading both of the piece of HD map data and the piece of SD map data causes a failure in reserving the time for the preparation operation of the second map update process on the piece of HD map data, the map update controller 13 may only perform the preparation operation of the second map update process on the piece of HD map data, and omit the preparation operation of the second map update process on the piece of SD map data. In such a case, the map update controller 13 performs the second map update process on the piece of SD map data by obtaining a piece of update map data from the map distribution server 30.

Embodiment 4 describes, as a procedure of operations of the map data management apparatus 10, the procedure in FIG. 28 obtained by adding Step S120 and replacing Step S102 with Step S121 in the procedure in FIG. 12 according to Embodiment 1. However, the procedure of operations of the map data management apparatus 10 according to Embodiment 4 may be a procedure obtained by adding Step S120 and replacing Step S102 with Step S121 in the procedure in FIG. 20 according to Embodiment 2.

In such a case, the map update controller 13 may update the piece of HD map data more preferentially than the piece of SD map data, in the process of updating the piece of map data in Step S110. Specifically, the map update controller 13 may complete updating at least the piece of HD map data in Step S110, and perform a part or all of processes of updating the piece of SD map data in parallel with provision of the piece of HD map data to the map application 23 (Step S101 and the subsequent processes).

Embodiment 4 describes an example where the piece of SD map data is applied to processes inside the map data management apparatus 10, such as the map-matching or a process of estimating a road along which the subject vehicle is traveling. However, the piece of SD map data may be provided to the map application 23 and applied to, for example, the navigation function to be executed by the map application 23, in the same manner as the piece of HD map data.

[Hardware Configuration of Map Data Management Apparatus]

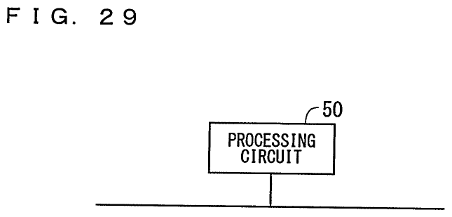

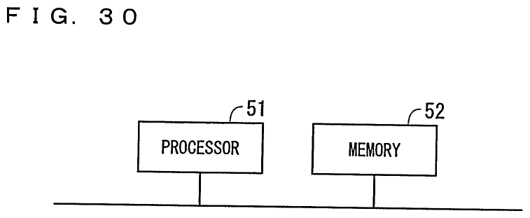

Each of FIGS. 29 and 30 illustrates an example hardware configuration of the map data management apparatus 10. Each function of the constituent elements of the map data management apparatus 10 illustrated in FIGS. 1, 13, 16, 25, and 26 is implemented by, for example, a processing circuit 50 illustrated in FIG. 29. Specifically, the map data management apparatus 10 includes the processing circuit 50 for providing, in response to a request from a map application, the map application with pieces of map data stored in a map database, obtaining, from a map distribution server, a piece of update map data that is a piece of latest map data of each of meshes, and updating the pieces of map data stored in the map database using the pieces of update map data. The processing circuit 50 may be dedicated hardware or a processor that executes a program stored in a memory (also referred to as a central processing unit (CPU), a processing unit, an arithmetic unit, a microprocessor, a microcomputer, or a digital signal processor (DSP)).

When the processing circuit 50 is dedicated hardware, it corresponds to, for example, a single circuit, a composite circuit, a programmed processor, a parallel-programmed processor, an application-specific integrated circuit (ASIC), a field-programmable gate array (FPGA), or any combination of these. Each function of the constituent elements of the map data management apparatus 10 may be implemented by a separate processing circuit, or the functions may be collectively implemented by a single processing circuit.

FIG. 30 illustrates an example hardware configuration of the map data management apparatus 10 when the processing circuit 50 includes a processor 51 that executes a program. Here, the functions of the constituent elements of the map data management apparatus 10 are implemented by, for example, software (software, firmware, or a combination of the software and the firmware). For example, the software is described as a program, and stored in a memory 52. The processor 51 performs the functions in each of the units by reading and executing the programs stored in the memory 52. Specifically, the map data management apparatus 10 includes the memory 52 for storing a program which, when executed by the processor 51, consequently performs processes of: providing, in response to a request from a map application, the map application with pieces of map data stored in a map database; obtaining, from a map distribution server, a piece of update map data that is a piece of latest map data of each of meshes; and updating the pieces of map data stored in the map database using the pieces of update map data. Put it differently, this program causes a computer to execute procedures or methods of the operations of the constituent elements of the map data management apparatus 10.

Here, examples of the memory 52 may include non-volatile or volatile semiconductor memories such as a random-access memory (RAM), a read-only memory (ROM), a flash memory, an erasable programmable read-only memory (EPROM), and an electrically erasable programmable read-only memory (EEPROM), a hard disk drive (HDD), a magnetic disc, a flexible disk, an optical disk, a compact disk, a mini disk, a Digital Versatile Disc (DVD), a drive device thereof, and further any a storage medium to be used in the future.

The configuration for implementing the functions of the constituent elements of the map data management apparatus 10 using one of the hardware and the software, etc., is described above. However, the configuration is not limited to this but a part of the constituent elements of the map data management apparatus 10 may be implemented by dedicated hardware, and another part of the constituent elements may be implemented by software, etc. For example, the processing circuit 50 functioning as the dedicated hardware can implement the functions of the part of the constituent elements, and the processing circuit 50 functioning as the processor 51 can implement the functions of the other part of the constituent elements through reading and executing a program stored in the memory 52.

As described above, the map data management apparatus 10 can implement each of the functions by hardware, software, etc., or any combinations of these.

Embodiments can be freely combined, and appropriately modified or omitted.

The description is in all aspects exemplifications, and numerous modifications and variations that have not yet been exemplified can be devised.

### EXPLANATION OF REFERENCE SIGNS

10 map data management apparatus, 11 map database, 12 map access unit, 13 map update controller, 14 update map data obtaining unit, 15 update necessity data storage, 16 update map data storage, 17 map-matching unit, 18 mesh connection management data storage, 20 in-vehicle apparatus, 21 communication device, 22 positioning unit, 23 map application, 24 prefetch map data storage, 30 map distribution server, 50 processing circuit, 51 processor, 52 memory.

1. A map data management apparatus, comprising:
a map database to store a piece of map data of each of meshes into which a map is partitioned in a mesh-shaped design;
a processor to execute a program; and
a memory to store the program which, when executed by the processor, performs processes of:
providing, in response to a request from a map application, the map application with the pieces of map data stored in the map database;
obtaining, from a map distribution server, a piece of update map data that is a piece of latest map data of each of the meshes; and
updating the pieces of map data stored in the map database using the pieces of update map data,
wherein the processor predicts meshes whose pieces of map data will be requested from the map application, identifies meshes whose pieces of map data stored in the map database are not latest as update-necessary meshes, from among the predicted meshes whose pieces of map data will be requested, performs a first map update process of immediately updating pieces of map data of the update-necessary meshes when the processor can update the pieces of map data of the update-necessary meshes before the map application requests the pieces of map data of the update-necessary meshes, and performs a second map update process of updating the pieces of map data of the update-necessary meshes at the timing that an operation of the map application satisfies a predefined condition when the processor cannot update the pieces of map data of the update-necessary meshes before the map application requests the pieces of map data of the update-necessary meshes.

2. The map data management apparatus according to claim 1,
wherein the predefined condition is at least one of the following:
end of an operation of the map application;
start of a next operation of the map application;
the fact that all the pieces of map data being provided to the map application have become latest; and
the fact that the map application has released the pieces of map data.

3. The map data management apparatus according to claim 1,
wherein the pieces of map data stored in the map database are pieces of high-definition map data including road shape information for each lane.

4. The map data management apparatus according to claim 1,
wherein the processor performs the second map update process on meshes in a predefined area including a mesh to which a current position belongs.

5. The map data management apparatus according to claim 1, further comprising
an update map data storage to store the pieces of update map data of the update-necessary meshes until the processor performs the second map update process, when the processor cannot update the pieces of map data of the update-necessary meshes before the map application requests the pieces of map data of the update-necessary meshes.

6. (canceled)

7. The map data management apparatus according to claim 5,
wherein when the processor cannot update the pieces of map data of the update-necessary meshes before the map application requests the pieces of map data of the update-necessary meshes and when the update map data storage does not have a free capacity large enough to store the pieces of update map data of the update-necessary meshes, the processor selects a piece of update map data to be stored in the update map data storage.

8. The map data management apparatus according to claim 1,
wherein in the first map update process, the processor updates the pieces of map data of the update-necessary meshes in order of increasing proximity from a starting mesh toward a traveling direction, the starting mesh being farthest one of meshes whose pieces of map data have been provided to the map application, from a current position toward the traveling direction.

9. The map data management apparatus according to claim 1,
wherein the pieces of map data stored in the map database include both of pieces of high-definition map data including road shape information for each lane, and pieces of standard map data including road shape information for each road,
the pieces of high-definition map data are provided to the map application,
the pieces of standard map data are used for map-matching for identifying a current position, and
the processor performs the first map update process and the second map update process on both of the pieces of high-definition map data and the pieces of standard map data.

10. The map data management apparatus according to claim 9,
wherein the processor updates the pieces of high-definition map data more preferentially than the pieces of standard map data.

11. (canceled)

12. The map data management apparatus according to claim 9,
wherein when the processor can update pieces of high-definition map data of the update-necessary meshes before the map application requests the pieces of map data of the update-necessary meshes but cannot update pieces of standard map data of the update-necessary meshes, the processor performs the first map update process on the pieces of high-definition map data of the update-necessary meshes and performs the second map update process on the pieces of standard map data of the update-necessary meshes.

13. A map data management apparatus, comprising:
a map database to store a piece of map data of each of meshes into which a map is partitioned in a mesh-shaped design;
a processor to execute a program; and
a memory to store the program which, when executed by the processor, performs processes of:
providing, in response to a request from a map application, the map application with the pieces of map data stored in the map database;
obtaining, from a map distribution server, a piece of update map data that is a piece of latest map data of each of the meshes; and
updating the pieces of map data stored in the map database using the pieces of update map data,
wherein the pieces of map data stored in the map database include pieces of high-definition map data including road shape information for each lane, and
the processor predicts, as meshes whose pieces of map data will be requested from the map application, meshes with pieces of high-definition map data that are connected from a mesh to which a current position belongs or meshes with pieces of high-definition map data of roads that are connected from a road in the mesh to which the current position belongs, identifies meshes whose pieces of map data stored in the map database are not latest as update-necessary meshes, from among the predicted meshes whose pieces of map data will be requested, and updates pieces of map data of the update-necessary meshes.

14. The map data management apparatus according to claim 13, further comprising
a mesh connection management data storage storing data indicating whether one of the pieces of high-definition map data exists in each of the meshes.

15. The map data management apparatus according to claim 14,
wherein the data stored in the mesh connection management data storage and indicating whether the piece of high-definition map data exists in each of the meshes is 1-bit data stored in an address corresponding to an ID of the mesh.

16. The map data management apparatus according to claim 13, further comprising
a mesh connection management data storage storing data indicating a mesh in which direction a road in each of the meshes is connected to.

17. The map data management apparatus according to claim 13,
wherein the processor updates the pieces of map data of the update-necessary meshes in order of increasing proximity from a starting mesh toward a traveling direction, the starting mesh being farthest one of meshes whose pieces of map data have been provided to the map application, from the current position toward the traveling direction.

18. The map data management apparatus according to claim 13,
wherein when a road that is connected from the road in the mesh to which the current position belongs has a branching point and a traveling direction at the branching point is not certain, the processor in predicting the meshes whose pieces of map data will be requested from the map application searches for, from the branching point to each branching direction, the meshes with the pieces of high-definition map data that are connected from the mesh to which the current position belongs or the meshes with the pieces of high-definition map data of the roads that are connected from the road in the mesh to which the current position belongs, and
when the road that is connected from the road in the mesh to which the current position belongs has the branching point and the traveling direction at the branching point becomes certain, the processor in predicting the meshes whose pieces of map data will be requested from the map application searches for, from the branching point toward the traveling direction, the meshes with the pieces of high-definition map data that are connected from the mesh to which the current position belongs or the meshes with the pieces of high-definition map data of the roads that are connected from the road in the mesh to which the current position belongs.

19. The map data management apparatus according to claim 13,
wherein the processor performs a first map update process of immediately updating the pieces of map data of the update-necessary meshes, when the processor can update the pieces of map data of the update-necessary meshes before the map application requests the pieces of map data of the update-necessary meshes, and
the processor performs a second map update process of updating the pieces of map data of the update-necessary meshes at the timing that an operation of the map application satisfies a predefined condition, when the processor cannot update the pieces of map data of the update-necessary meshes before the map application requests the pieces of map data of the update-necessary meshes.

20. The map data management apparatus according to claim 13,
wherein the pieces of map data stored in the map database further include pieces of standard map data including road shape information for each road,
the pieces of high-definition map data are provided to the map application,
the pieces of standard map data are used for map-matching for identifying the current position, and
the processor updates both of the pieces of high-definition map data and the pieces of standard map data.

21. The map data management apparatus according to claim 20,
wherein the processor updates the pieces of high-definition map data more preferentially than the pieces of standard map data.

22. (canceled)

23. A map data management method for managing a map database storing a piece of map data of each of meshes into which a map is partitioned in a mesh-shaped design, the method comprising:
providing, in response to a request from a map application, the map application with the pieces of map data stored in the map database;
obtaining, from a map distribution server, a piece of update map data that is a piece of latest map data of each of the meshes; and
updating the pieces of map data stored in the map database using the pieces of update map data,
wherein the updating the pieces of map data stored in the map database includes:
predicting meshes whose pieces of map data will be requested from the map application;
identifying meshes whose pieces of map data stored in the map database are not latest as update-necessary meshes, from among the predicted meshes whose pieces of map data will be requested;
performing a first map update process of immediately updating pieces of map data of the update-necessary meshes, when the pieces of map data of the update-necessary meshes can be updated before the map application requests the pieces of map data of the update-necessary meshes; and
performing a second map update process of updating the pieces of map data of the update-necessary meshes at the timing that an operation of the map application satisfies a predefined condition, when the pieces of map data of the update-necessary meshes cannot be updated.

24. (canceled)
